(19) United States
(12) Patent Application Publication
(10) Pub. No.: US 2008/0079280 A1
(43) Pub. Date: Apr. 3, 2008

(54) Vehicle-body supporting apparatus and vehicle-body supporting system

(75) Inventors: Sachio Nakamura, Kanagawa (JP); Tuneo Morikawa, Kanagawa (JP)

Correspondence Address: GREER, BURNS & CRAIN, 300 S WACKER DR, 25TH FLOOR, CHICAGO, IL, 60606, US

(73) Assignee: The Yokohama Rubber Co., Ltd., Tokyo (JP)

(21) Appl. No.: 11/904,881

(22) Filed: Sep. 28, 2007

(30) Foreign Application Priority Data
Sep. 29, 2006 (JP) 2006-269421
Sep. 29, 2006 (JP) 2006-269422
Sep. 29, 2006 (JP) 2006-269423

(51) Int. Cl. B62D 23/00

(52) U.S. Cl. 296/35.3

(57) ABSTRACT

A vehicle-body supporting apparatus is provided between a vehicle body of a vehicle and a wheel to support the vehicle body. The vehicle-body supporting apparatus includes an air chamber that is filled with a gaseous matter, a vibration input unit that inputs at least one of vibration from the vehicle body and vibration from the wheel to the air chamber by reciprocating relative to the air chamber, a fluid path that the gaseous matter in the air chamber passes through, and a fluid-path opening/closing unit that is attached to the fluid path to open/close the fluid path at predetermined frequency corresponding to a frequency of reciprocation of the vibration input unit relative to the air chamber.

### BACKGROUND OF THE INVENTION

1. Field of the Invention

The present invention relates to a vehicle-body supporting apparatus and a vehicle-body supporting system adapted to support a vehicle, such as an automotive, bus, and truck.

2. Description of the Related Art

Conventionally, a damping mechanism is employed to support a suspension of a vehicle or railway vehicle or a structural object, when vibration transmission or shock transfer to or from these objects is not desirable. For example, U.S. Pat. No. 4,635,909 describes an air spring in which: an inner space of a cylinder is divided into two chambers by a piston; a passageway is formed in the piston to communicate two chambers with each other; a valve composed of two metal foils is arranged in the passageway; and an input of the same frequency as the self-sustained frequency of the valve is prevented from being transmitted to a portion supported by the spring. When such an air spring is employed in a damper of a vehicle suspension, resonant amplification can be prevented by matching the resonant frequency of the portion supported by the spring and the self-sustained frequency of the valve. Further, an undesirable transfer of certain input to the vehicle can be prevented, when the self-sustained frequency of the valve is made to coincide with the frequency of the input.

Mass supported by a suspension apparatus of a vehicle running on a road or a railway vehicle can vary. For example, mass supported by the suspension apparatus of the vehicle can vary, depending on the number of passengers or movable load, which results in the change of natural frequency of a vibrating system. The change in the natural frequency of the vibrating system induces the deterioration in the function of suppressing the resonant amplification.

### SUMMARY OF THE INVENTION

It is an object of the present invention to at least partially solve the problems in the conventional technology.

According to one aspect of the present invention, a vehicle-body supporting apparatus is provided between a vehicle body of a vehicle and a wheel to support the vehicle body. The vehicle-body supporting apparatus includes: an air chamber that is filled with a gaseous matter; a vibration input unit that inputs at least one of vibration from the vehicle body and vibration from the wheel to the air chamber by reciprocating relative to the air chamber; a fluid path that the gaseous matter in the air chamber passes through; and a fluid-path opening/closing unit that is attached to the fluid path to open/close the fluid path at predetermined frequency corresponding to a frequency of reciprocation of the vibration input unit relative to the air chamber.

According to another aspect of the present invention, the vehicle-body supporting apparatus may further include an air amount detector that detects an amount of the gaseous matter filling the air chamber, and an air supply unit that replenishes the gaseous matter into the air chamber when the amount of the gaseous matter filling in the air chamber as detected by the air amount detector is equal to or smaller than a predetermined threshold.

According to still another aspect of the present invention, in the vehicle-body supporting apparatus, the air chamber may include a first air chamber and a second air chamber, and the vibration input unit may be arranged between the first air chamber and the second air chamber, and the fluid path connects the first air chamber and the second air chamber.

According to still another aspect of the present invention, in the vehicle-body supporting apparatus, the second air chamber may be arranged opposite to the first air chamber, and the vibration input unit may be supported by the first air chamber and the second air chamber, and a load-supporting area of the vibration input unit in contact with the first air chamber may be larger than a load-supporting area of the vibration input unit in contact with the second air chamber.

According to still another aspect of the present invention, the vehicle-body supporting apparatus may further include a vibration detector that is attached to the vehicle to detect at least one of sprung vibration and unsprung vibration of the vehicle, and the vibration detector may find a frequency with a maximum vibrational power, and the fluid-path opening/closing unit may be opened/closed at the frequency found, an integral multiple of the frequency found, or a frequency obtained by dividing the frequency found by an integer.

According to still another aspect of the present invention, in the vehicle-body supporting apparatus, power of the frequency with the maximum vibrational power may be identified, and a ratio of an opening time to a closing time of the opening/closing of the fluid-path opening/closing unit may be changed according to a magnitude of the vibrational power.

According to still another aspect of the present invention, in the vehicle-body supporting apparatus, the vibration detector may find plural frequencies in a descending order of a magnitude of the vibrational power, and the fluid-path opening/closing unit may be opened/closed at the plural frequencies found, integral multiples of the frequencies found, or frequencies obtained by dividing the plural frequencies by an integer.

According to still another aspect of the present invention, in the vehicle-body supporting apparatus, a ratio of an opening time to a closing time of the opening/closing of the fluid-path opening/closing unit may be changed for each of the plural frequencies found according to a magnitude of the vibrational power of each of the plural frequencies found.

According to still another aspect of the present invention, the vehicle-body supporting apparatus may further include an elastic body that supports the vibration input unit.

According to still another aspect of the present invention, a vehicle-body supporting system includes: vehicle-body supporting apparatuses each arranged between a vehicle body of a vehicle and a wheel to support the vehicle body, each of the vehicle-body supporting apparatuses including a first air chamber and a second air chamber filled with a gaseous matter, and a vibration input unit that is arranged between the first air chamber and the second air chamber to input at least one of vibration from the vehicle body and vibration from the wheel to the first air chamber and the second air chamber by reciprocating relative to the first air chamber and the second air chamber; a first fluid path that connects the first air chamber of one vehicle-body supporting apparatus of a pair of the vehicle-body supporting apparatuses and the second air chamber of another vehicle-body supporting apparatus of the pair of the vehicle-body supporting apparatuses; a second fluid path that connects the second air chamber of the one vehicle-body supporting apparatus and the first air chamber of the another vehicle-body supporting apparatus; and a fluid-path opening/closing unit that is attached to a third fluid path connecting the first fluid path and the second fluid path with each other to open/close the third fluid path at a predetermined frequency corresponding to a frequency of reciprocation of the vibration input unit relative to the first air chamber and the second air chamber.

According to still another aspect of the present invention, in the vehicle-body supporting system, the pair of the vehicle-body supporting apparatuses may be attached to the vehicle one at a right and another at a left.

According to still another aspect of the present invention, in the vehicle-body supporting system, the pair of the vehicle-body supporting apparatuses may be attached to the vehicle both at a same side of the vehicle, and one at a front and another at a rear.

According to still another aspect of the present invention, in the vehicle-body supporting system, the pair of the vehicle-body supporting apparatuses may be attached to the vehicle at diagonal positions.

According to still another aspect of the present invention, the vehicle-body supporting system may further include a vibration detector that is attached to the vehicle to detect at least one of sprung vibration and unsprung vibration of the vehicle, wherein a vibrational component detected by the vibration detector and having a vibrational power equal to or higher than a predetermined vibrational power may be selected as a frequency of vibration whose transmission is to be damped, and the fluid-path opening/closing unit may be opened/closed at the selected frequency of the vibration whose transmission is to be damped, an integer multiple of the selected frequency, or a frequency obtained by dividing the selected frequency by an integer.

According to still another aspect of the present invention, in the vehicle-body supporting system, the vibrational component detected by the vibration detector and having a vibrational power equal to or higher than the predetermined vibrational power may be selected as a frequency of vibration whose transmission is to be damped, and a ratio of an opening time to a closing time of opening/closing of the fluid-path opening/closing unit may be changed according to a magnitude of each of the vibrational power.

According to still another aspect of the present invention, in the vehicle-body supporting system, the vibrational component having a vibrational power equal to or higher than the predetermined vibrational power may be selected as a frequency of vibration whose transmission is to be damped, plural frequencies are selected in a descending order of magnitude of the vibrational power, and the fluid-path opening/closing unit may be opened/closed at integral multiples of the selected plural frequencies or at frequencies obtained by dividing the selected plural frequencies by an integer.

According to still another aspect of the present invention, in the vehicle-body supporting system, plural frequencies may be selected in a descending order of magnitude of the vibrational power from the plural frequencies set, and a ratio of an opening time to a closing time of the opening/closing of the fluid-path opening/closing unit may be changed for each of the frequencies selected according to the magnitude of the vibrational power of the frequencies selected.

According to still another aspect of the present invention, a vehicle-body supporting system includes a vehicle-body supporting apparatus that is arranged between a vehicle body of a vehicle and a wheel to support the vehicle body, the vehicle-body supporting apparatus including an air chamber that is filled with a gaseous matter, and a vibration input unit that inputs at least one of vibration from the vehicle and vibration from the wheel to the air chamber by reciprocating relative to the air chamber; an air storage chamber that stores the gaseous matter filling the air chamber inside; a fluid path that connects the air chamber of the vehicle-body supporting apparatus and the air storage chamber and a fluid-path opening/closing unit that is attached to the fluid path to open/close the fluid path at a predetermined frequency corresponding to a frequency of reciprocation of the vibration input unit relative to the air chamber.

According to still another aspect of the present invention, in the vehicle-body supporting system, the air chambers of plural vehicle-body supporting apparatuses may be connected to the corresponding air storage chambers, respectively.

According to still another aspect of the present invention, in the vehicle-body supporting system, the air chambers of at least one set of the vehicle-body supporting apparatuses are connected to the common air storage chamber.

According to still another aspect of the present invention, in the vehicle-body supporting system, the air chambers of all the vehicle-body supporting apparatuses may be connected to the common air storage chamber.

According to still another aspect of the present invention, the vehicle-body supporting system may further include a vibration detector that is attached to the vehicle to detect at least one of sprung vibration and unsprung vibration of the vehicle, wherein vibration detected by the vibration detector and having a vibrational power equal to or higher than a predetermined vibrational power may be selected as vibration whose transmission is to be damped, and the fluid-path opening/closing unit may open/close the fluid path at a selected frequency of the vibration whose transmission is to be damped, an integral multiple of the frequency of the selected vibration, or a frequency obtained by dividing the selected vibration by an integer.

According to still another aspect of the present invention, in the vehicle-body supporting system, power of the predetermined frequency set may be identified, and a ratio of an opening time to a closing time of the opening/closing of the fluid-path opening/closing unit may be changed according to a magnitude of vibrational power of the predetermined frequency set.

According to still another aspect of the present invention, in the vehicle-body supporting system, plural frequencies may be selected in a descending order of magnitude of the vibrational power from frequencies of plural input vibrations detected, and the fluid-path opening/closing unit may be opened/closed at plural frequencies selected, integer multiples of the frequencies selected, or frequencies obtained by dividing the frequencies selected by an integer.

According to still another aspect of the present invention, in the vehicle-body supporting system, plural frequencies may be selected in a descending order of magnitude of vibrational power from frequencies of plural input vibrations detected, and a ratio of an opening time to a closing time of the opening/closing of the fluid-path opening/closing unit may be changed for each of the frequencies selected according to magnitude of power of the frequencies selected.

According to still another aspect of the present invention, in the vehicle-body supporting system, the vehicle-body supporting apparatuses may support front wheels and rear wheels of the vehicle, and a frequency of pitching of the vehicle is set as the predetermined frequency, and the fluid-path opening/closing units may open/close the fluid paths.

According to still another aspect of the present invention, in the vehicle-body supporting system, the vehicle-body supporting apparatuses may support left wheels and right wheels of the vehicle, and a frequency of roll of the vehicle may be set as the predetermined frequency, and the fluid-path opening/closing units may open/close the fluid paths.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a schematic diagram of a configuration of a vehicle-body supporting apparatus according to a first embodiment;

FIG. 1B is a schematic diagram of another example of a fluid-path opening/closing unit;

FIG. 2A is a schematic diagram of another configuration example of the vehicle-body supporting apparatus according to the first embodiment;

FIG. 2B is a schematic diagram of still another configuration example of the vehicle-body supporting apparatus according to the first embodiment;

FIG. 2C is a schematic diagram of still another configuration example of the vehicle-body supporting apparatus according to the first embodiment;

FIG. 2D is a schematic diagram of still another configuration example of the vehicle-body supporting apparatus according to the first embodiment;

FIG. 2E is a schematic diagram of still another configuration example of the vehicle-body supporting apparatus according to the first embodiment;

FIG. 2F is a schematic diagram of still another configuration example of the vehicle-body supporting apparatus according to the first embodiment;

FIG. 3 is a conceptual diagram of the vehicle-body supporting apparatuses according to the first embodiment arranged in a vehicle;

FIG. 4A is a schematic diagram of another example of the vehicle-body supporting apparatus according to the first embodiment and a vehicle-body supporting system using the same;

FIG. 4B is a schematic diagram of still another example of the vehicle-body supporting apparatus according to the first embodiment and a vehicle-body supporting system using the same;

FIG. 4C is a schematic diagram of still another example of the vehicle-body supporting apparatus according to the first embodiment and a vehicle-body supporting system using the same;

FIG. 5 is a schematic diagram of a configuration of a vibration transmission damping apparatus according to the first embodiment;

FIG. 6 is a functional block diagram of components performing Fourier analysis for the control of the vehicle-body supporting apparatus according to the first embodiment;

FIG. 7 is a diagram for explaining a first control of the vehicle-body supporting apparatus according to the first embodiment;

FIG. 8 is a diagram for explaining the first control of the vehicle-body supporting apparatus according to the first embodiment;

FIG. 9 is a diagram for explaining the first control of the vehicle-body supporting apparatus according to the first embodiment;

FIG. 10 is a diagram for explaining the first control of the vehicle-body supporting apparatus according to the first embodiment;

FIG. 11 is a diagram for explaining a second control of the vehicle-body supporting apparatus according to the first embodiment;

FIG. 12A is a diagram for explaining the second control of the vehicle-body supporting apparatus according to the first embodiment;

FIG. 12B is a diagram for explaining the second control of the vehicle-body supporting apparatus according to the first embodiment;

FIG. 13 is a diagram for explaining the second control of the vehicle-body supporting apparatus according to the first embodiment;

FIG. 14 is a diagram for explaining the second control of the vehicle-body supporting apparatus according to the first embodiment;

FIG. 15 is a diagram of piping arrangement in the vehicle-body supporting system according to a second embodiment;

FIG. 16 is a diagram of an example where air chambers of respective vehicle-body supporting apparatuses arranged to the right and the left of a vehicle are connected in the vehicle-body supporting system according to the second embodiment;

FIG. 17 is a diagram of an example where air chambers of respective vehicle-body supporting apparatuses arranged in the front and the rear of a vehicle are connected in the vehicle-body supporting system according to the second embodiment;

FIG. 18 is a diagram of an example where air chambers of vehicle-body supporting apparatuses diagonally arranged are connected among vehicle-supporting apparatuses attached to four portions at the front right, font left, rear right, and rear left of a vehicle in the vehicle-body supporting system according to the second embodiment;

FIG. 19 is a schematic diagram of a vehicle-body supporting system according to a third embodiment shown for explaining an example of a control of the vehicle-body supporting system according to the third embodiment; and

FIG. 20 is a diagram for explaining a behavior of a vehicle.

### DETAILED DESCRIPTION OF THE PREFERRED EMBODIMENTS

Exemplary embodiments of the present invention will be described in detail below with reference to the accompanying drawings. It should be noted that the present invention is not limited to the embodiments. Components of the embodiments may include those which can be readily achieved by those skilled in the art, or those equivalent to, i.e., those rest within the equivalent scope of the components readily achieved by those skilled in the art.

According to the first embodiment, a fluid path, which is connected to an air chamber filled with a gaseous matter such as air and nitrogen for supporting the load, is opened/closed periodically so that the air in the air chamber is partially released to the outside (into the air) or to another air chamber. As a result, the spring stiffness of the air chamber decreases against an external force having the same period as the frequency of the opening/closing operations of the fluid path. The first embodiment utilizes this characteristic. The first embodiment is characterized in that a vibration damping effect can be exerted on the supported mass (i.e., mass of the vehicle) even when the natural frequency of a vibrating system changes. When the fluid is described as being “released”, it means that the gaseous matter in the air chamber is discharged outside the air chamber if there is only one, air chamber, and that the gaseous matter in a high-pressure side air chamber moves to a low pressure side air chamber if there are two air chambers separated by a vibration input unit (such as a piston) (the same applies to the following description).

When there is only one air chamber that support the load (i.e., mass of the vehicle), a fluid-path opening/closing unit (such as an on-off valve) is provided in the fluid path to release the air in the air chamber to the outside. The fluid-path opening/closing unit is opened and closed at predetermined frequency corresponding to the vibrational frequency of the supported load (i.e., mass of the vehicle), whereby part of the air in the air chamber is released to the outside of the air chamber (the same applies to the following description).

When there are two air chambers that support the load, two air chambers are filled with a gaseous matter to support the load, and a vibration input unit that reciprocates between the two air chambers in a relative manner to input the vibration to the two air chambers, a fluid path that communicates the two air chambers, and a fluid-path opening/closing unit (e.g., on-off valve) arranged in the fluid path are provided. The fluid-path opening/closing unit is opened/closed at predetermined frequency corresponding to the frequency of relative reciprocation of the vibration input unit with respect to the two air chambers.

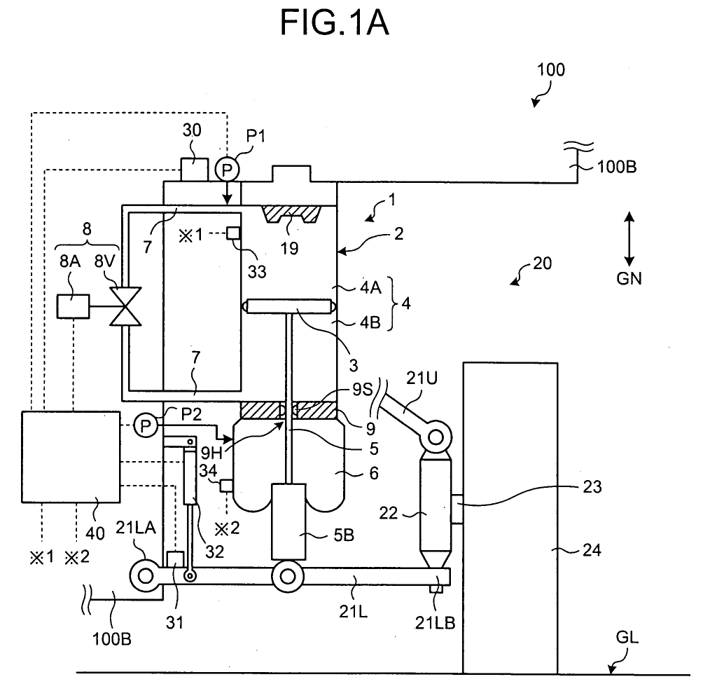

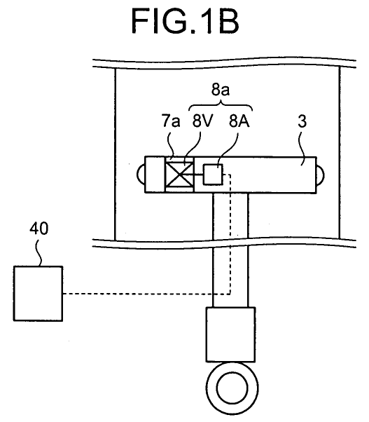

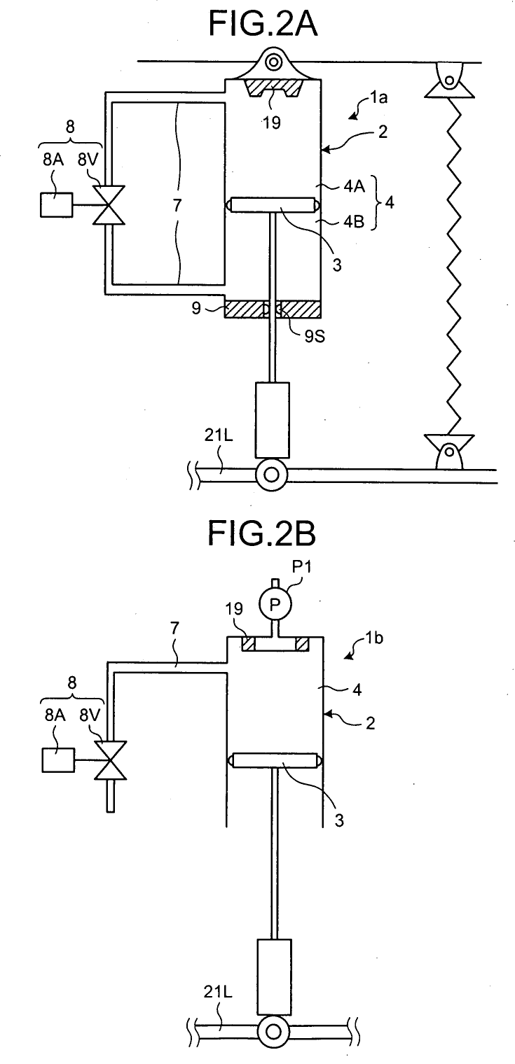

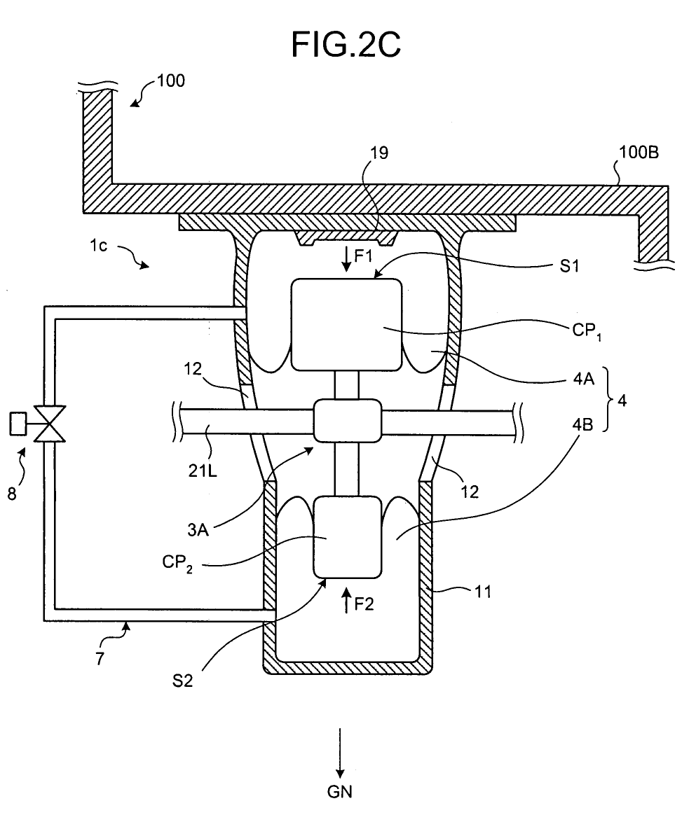

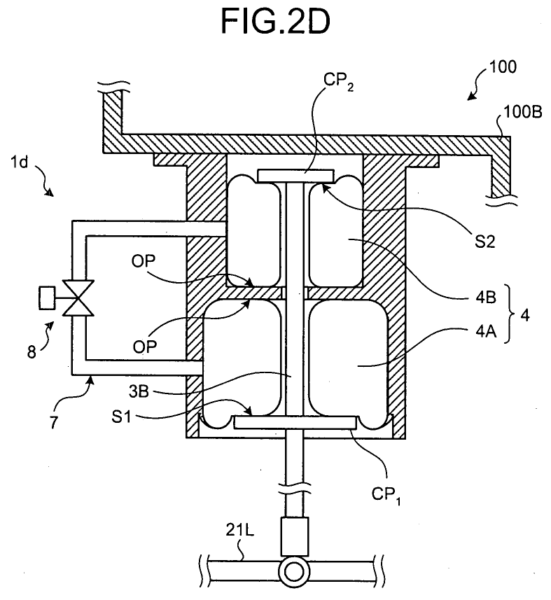

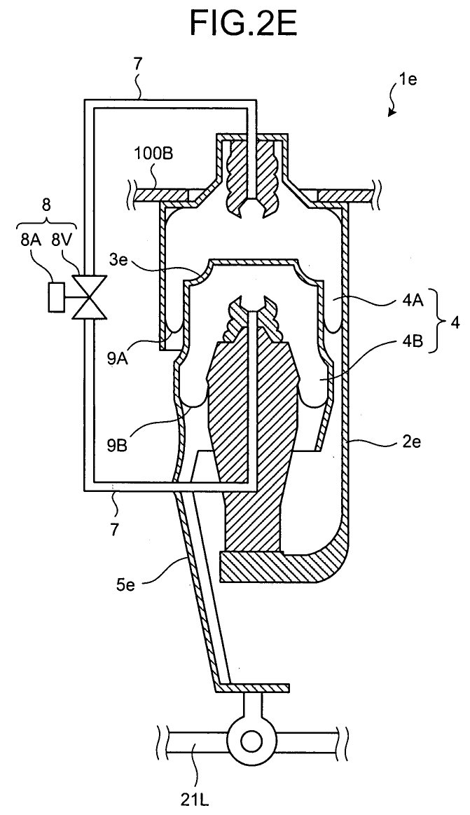

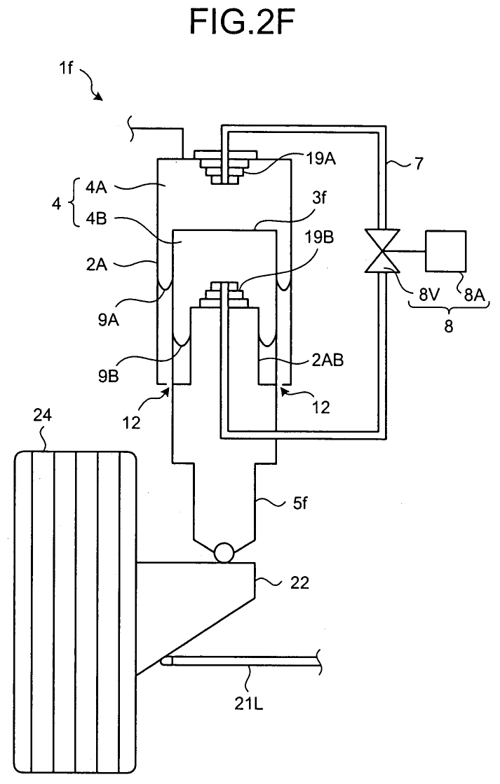

FIG. 1A is a, schematic diagram of a configuration of a vehicle-body supporting apparatus according to the first embodiment. FIG. 1B is a schematic diagram of another example of the fluid-path opening/closing unit. FIGS. 2A to 2D are schematic diagrams of other configuration examples of the vehicle-body supporting apparatus according to the first embodiment. A vehicle-body supporting apparatus 1 according to the first embodiment works as a buffer apparatus of a suspension system 20 provided in a vehicle 100, in other words, works as a structural body including a spring and a vibration attenuation unit (such as a damper). In the first embodiment, a structural body supported by the vehicle-body supporting apparatus 1 is a vehicle body 100B of the vehicle 100.

The vehicle-body supporting apparatus 1 includes a cylinder 2, a piston 3 which is attached to the cylinder 2 so that the piston 3 can reciprocate inside the cylinder 2, a fluid path 7, and a fluid-path opening/closing unit 8 which is arranged in the fluid path 7. An air chamber 4 is formed in the cylinder 2 and filled with a gaseous matter (i.e., air in the first embodiment) pressurized to a predetermined pressure level. A pressure adjuster such as a pump may be attached to the air chamber 4 so that the gaseous matter can be supplied to the air chamber 4.

The air chamber 4 is divided into a first air chamber 4A and a second air chamber 4B by the piston 3. The piston 3 serves as a vibration input unit that inputs the vibration from an object to which the vehicle-body supporting apparatus 1 is attached (in the first embodiment, the object is the vehicle body 100B of the vehicle 100 and a lower arm 21L of the suspension system 20) to the air chamber 4 (i.e., the first and the second air chambers 4A and 4B) by reciprocating relative to the air chamber 4. The first air chamber 4A and the second air chamber 4B may be configured separately from a flexible material such as a rubber film, and the piston 3 may be sandwiched between the first and the second air chambers 4A and 4B.

A piston rod 5 is attached to the piston 3. The piston rod 5 has one end provided with a bracket 5B which is attached to the lower arm 21L of the suspension system 20 to which the vehicle-body supporting apparatus 1 is attached. The piston 3 is connected to the lower arm 21L of the suspension system 20 via the piston rod 5 and the bracket 5B. When the lower arm 21L moves in a direction of an arrow GN shown in FIG. 1A, the piston 3 reciprocates inside the cylinder 2 in conjunction with the lower arm 21L.

As shown in FIG. 1A, a vehicle-body acceleration sensor 30 is attached to the vehicle body 100B of the vehicle 100. The vehicle-body acceleration sensor 30 can detect acceleration of the vehicle body 100B in a direction orthogonal to a road surface GL (i.e., acceleration of a portion of the vehicle 100 above the spring). Based on the detected acceleration, the frequency of the vibrations of the portion above the spring can be found. Further, a suspension-system acceleration sensor 31 is attached to the lower arm 21L of the suspension system 20. The suspension-system acceleration sensor 31 can detect the movements of the lower arm 21L so as to find the acceleration of a portion of the vehicle 100 under the spring in the direction orthogonal to the road surface GL. Based on the found acceleration, the frequency of the vibrations of the portion under the spring can be found. Thus, each of the vehicle-body acceleration sensor 30 and the suspension-system acceleration sensor 31 works as a vibration detector. More specifically, the vehicle-body acceleration sensor 30 works as a sprung vibration detector which detects the vibrations of the portion of the vehicle 100 above the spring, whereas the suspension-system acceleration sensor 31 works as an unsprung vibration detector which detects the vibrations of a portion of the vehicle 100 under the spring.

Further, a stroke sensor 32 is attached to the lower arm 21L of the suspension system 20. The stroke sensor 32 allows for the detection of the vehicle level of the vehicle 100. The stroke sensor 32 also provides information on the stroke of the vehicle-body supporting apparatus 1. Therefore, the vehicle level of the vehicle 100 can be maintained at a fixed level through replenishment of air in the air chamber 4 or in an air spring 6 described later, or through the discharge of the air from the air spring 6 and the like, even when the passenger of the vehicle changes or the load of the vehicle 100 changes so as to cause the variations in vehicle level.

As shown in FIG. 1A, a first pump P1 may be connected to the fluid path 7 connected to the air chamber 4 so as to work as a fluid supply unit for the air chamber 4. It is desirable that a second pump P2 be connected to the air spring 6 as the fluid supply unit. Further, the vehicle-body supporting apparatus 1 may include an air-chamber pressure sensor 33 which measures the pressure in the air chamber 4, and an air-spring pressure sensor 34 which measures the pressure inside the air spring 6. Since the volume of the air spring 6 can be found based on the value detected by the stroke sensor 32, the amount of air in the air spring 6 can be known based on the detected value of the stroke sensor 32 and the pressure in the air spring 6′ as acquired from the air-spring pressure sensor 34. Thus, the amount of gaseous matter filling the air chamber 4 or the air spring 6 can be detected with the use of an air amount detector which can be the air-chamber pressure sensor 33, the stroke sensor 32, and the air-spring pressure sensor 34.

When the amount of the gaseous matter in the air chamber 4 or the amount of the gaseous matter in the air spring 6 detected by the stroke sensor 32 as the air amount detector is equal to or below a predetermined threshold value, the vehicle-body supporting apparatus 1 is unable to maintain the vehicle level of the vehicle body 100B at a predetermined level. In this case, the gaseous matter is replenished to the air chamber 4 or the air spring 6 via the first pump P1 or the second pump P2. In this way, the vehicle-body supporting apparatus 1 can remain able to maintain the vehicle level of the vehicle body 100B so as to realize safe running of the vehicle 100.

A bottom plate 9 is attached as a sealing member to a portion of the cylinder 2 where the piston rod 5 protrudes. The piston rod 5 runs through a through hole 9H of the bottom plate 9. A seal 9S is attached to the through hole 9H, so as to minimize the amount of the gaseous matter leaking out from the second air chamber 4B through the gap formed between the piston rod 5 and the through hole 9H.

In the embodiment, the air spring 6 as an elastic body is arranged between the bracket 5B and the bottom plate 9 (i.e., between the bracket 5B and the second air chamber 4B) so as to work as a third air chamber. A main function of an air spring configured with the first air chamber 4A and the second air chamber 4B of the vehicle-body supporting apparatus 1 is to give the vehicle-body supporting apparatus 1 frequency selective characteristics. The vehicle-body supporting apparatus 1 supports the mass of the vehicle body 100B with a force expressed as a difference between a load bearing force of the pressure inside the air spring 6 and the pressure inside the first air chamber 4A, and a force of the pressure inside the second air chamber 4B. The presence of the force of the second air chamber 4B necessitates the presence of the additional air spring 6. Here, the air spring 6 may be replaced with a different elastic body such as a coil spring and a leaf spring, so as to support the load of the vehicle body 100B.

Even when the vehicle-body supporting apparatus itself does not have the air spring 6 (see FIG. 1A) as in the case of a vehicle-body supporting apparatus 1a shown in FIG. 2A, the mass of the vehicle body 100B to which the vehicle-body supporting apparatus 1a is attached can be supported by another elastic body (such as a coil spring). Further, if the pressure in the air chamber 4 can be maintained at a predetermined level through the supply of a gaseous matter to the air chamber 4 in real time by the pump P1 which serves as a fluid supply unit as in a vehicle-body supporting apparatus 1b shown in FIG. 2B, the single air chamber 4 may be sufficient and an additional spring mechanism may not be necessary.

Further, a stopper member 19 is arranged inside the vehicle-body supporting apparatus 1, 1a, or the like of the first embodiment at a position opposite to the piston 3 at the attachment side of the vehicle body. In this case, the stopper member 19 can support the sprung mass even when the air in the air spring 6, the first air chamber 4A, and the like comes out to disable the supporting of the sprung mass of the vehicle 100 by the air pressure. Thus, even when the air leakage occurs in the air spring 6, the first air chamber 4A, and the like, the stopper member 19 directly contacts with the piston 3 so as to support the mass of the vehicle body 100B. Therefore, the vehicle body 100B can run at least at low speed. As a result, even when the air leakage occurs in the air spring 6, the first air chamber 4A, and the like, the vehicle 100 can run slowly until arriving at a repair shop or the like.

The lower arm 21L which forms a part of the suspension system 20 of the vehicle 100 has a first end 21LA attached to the vehicle body 100B and a second end 21LB to which a wheel bracket 22 is attached for the attachment of a wheel 24. The wheel 24 is attached to the wheel bracket 22 via an axle shaft 23. The wheel bracket 22 is attached to the vehicle body 100B via the lower arm 21L and ah upper arm 21U (an attachment of the upper arm 21U to the vehicle body is not shown).

The vehicle-body supporting apparatus 1 and the lower arm 21L of the suspension system 20 are connected with each other via the bracket 5B attached to the piston rod 5 of the vehicle-body supporting apparatus 1. When the wheel 24 moves in the direction of the arrow GN due to shocks from the road surface GL or the like, the lower arm 21L swings about the first end 21LA. Then, the piston 3 of the vehicle-body supporting apparatus 1 reciprocates in the cylinder 2 in conjunction with the lower arm 21L.

According to the reciprocation of the piston 3, the volumes of the first air chamber 4A and the second air chamber 4B change. For example, when the lower arm 21L moves up to make the total length of the vehicle-body supporting apparatus 1 shorter, the piston 3 moves upward accordingly. In this case, the volume of the first air chamber 4A decreases, while the volume of the second air chamber 4B increases. Thus, the first air chamber 4A and the second air chamber 4B generate a force (i.e., repulsive force) to push back the piston 3 in a direction opposite to the moving direction of the piston 3. Thus, the vehicle-body supporting apparatus 1 works as an air spring so as to absorb the shocks applied to the wheel 24 from the road surface GL and to support the mass of the vehicle body 100B.

In the first embodiment, the first air chamber 4A and the second air chamber 4B are connected with each other via the fluid path 7 through which the gaseous matter filling the first and the second air chambers 4A and 4B passes. Further, an on-off valve 8V is provided in the fluid path 7 so as to form the fluid-path opening/closing unit 8. Specifically, the on-off valve 8V is arranged between the first air chamber 4A and the second air chamber 4B. The fluid-path opening/closing unit 8 includes the on-off valve 8V, an actuator 8A (e.g., solenoid, piezoelectric element such as piezo element, and ultrasonic motor) which opens/closes the on-off valve 8V under the control of a vibration damping control apparatus 40. When the actuator 8A closes the on-off valve 8V, the first air chamber 4A is cut off from the second air chamber 4B, so that the gaseous matter cannot move between the first and the second air chambers 4A and 4B. On the other hand, when the actuator 8A opens the on-off valve 8V, the first air chamber 4A is communicated with the second air chamber 4B, so that the gaseous matter can move between the first air chamber 4A and the second air chamber 4B via the fluid path 7.

Here, a fluid-path opening/closing unit 8a may be provided in a communicating hole 7a of the piston 3 as shown in FIG. 1B. In this case, the communicating hole 7a serves as the fluid path. When the fluid-path opening/closing unit 8a is embedded in and attached to the piston 3 or the piston rod 5 as described above, the fluid-path opening/closing unit and the fluid path do not need to be provided outside the vehicle-body supporting apparatus 1, whereby the vehicle-body supporting apparatus 1 can be made compact. Further, since the fluid path connecting the first air chamber 4A and the second air chamber 4B is not arranged outside the vehicle-body supporting apparatus 1, the fluid path would not be damaged by pebbles or the like while the vehicle 100 is running, whereby the vehicle-body supporting apparatus 1 can enjoy an enhanced reliability.

The vehicle-body supporting apparatus 1 of the first embodiment damps the transmission of vibrations of a notch frequency to the vehicle body 100B by working as a notch filter which decreases the spring stiffness with respect to the vibrations of the notch frequency. Thus, the vehicle-body supporting apparatus 1 can avoid resonance amplification in the vibrating system of the vehicle 100 and prevent transmission of uncomfortable vibrations to the vehicle body 100B. As described above, the vehicle-body supporting apparatus 1 of the first embodiment has an effect of damping the transmission of vibrations to the vehicle body 100B. In other words, the vehicle-body supporting apparatus 1 of the first embodiment has an effect like a vibration attenuation apparatus.

The notch filter is a filter having functions of filtering out the vibrations of a specific frequency and allowing the transmission of vibrations of frequencies other than the specific frequency. The vehicle-body supporting apparatus 1 of the first embodiment damps the transmission of vibrations of a specific frequency (or a frequency band) by working like a notch filter. Specifically, the vehicle-body supporting apparatus 1 damps the transmission of vibrations of a specific frequency (or plural prominent frequencies) between the wheel 24 (see FIG. 1A) and the vehicle body 100B.

Notch frequency is a frequency of vibrations to be filtered out by the notch filter. For example, the notch frequency may be set to the natural frequency of the vibrating system of the vehicle 100 which includes the vehicle body 100B and the vehicle-body supporting apparatus 1. When the vibrations of the natural frequency are transmitted to the vehicle body 100B, the vibrations of the vehicle body 100B are amplified due to resonance (resonance amplification). Therefore, the transmission of such vibrations to the vehicle body 100B needs to be blocked. In other words, the vibrations of the natural frequency are the vibrations of a frequency whose transmission to the vehicle body 100B should be damped desirably. When the notch frequency of the vehicle-body supporting apparatus 1 of the first embodiment is set to the natural frequency, the transmission of the vibrations of the natural frequency to the vehicle body 100B can be damped, whereby the effect of resonance amplification can be suppressed.

To lower the spring stiffness of the vehicle-body supporting apparatus 1 with respect to the vibrations of the notch frequency, what is necessary is to open/close the fluid-path opening/closing unit 8 not only at the notch frequency (i.e., specific frequency corresponding to the frequency of the reciprocation of the piston 3 relative to the air chamber 4) but also at a harmonic frequency which is an integral multiple of the notch frequency, or at a frequency obtained by dividing the notch frequency by an integer according to the theory of Fourier expansion. Thus, the vehicle-body supporting apparatus 1 of the first embodiment supports the load with a lower transmissibility for the notch frequency while maintaining a relatively high transmissibility, in comparison with that for the notch frequency, for frequencies other than the notch frequency. Such a characteristic is particularly important for supporting a static load (for which the vibrational frequency corresponds to zero).

A vehicle-body supporting apparatuses shown in FIGS. 2C and 2D will be described. A vehicle-body supporting apparatus 1c shown in FIG. 2C includes the first air chamber 4A and the second air chamber 4B filled with a gaseous matter and arranged opposite to each other. The first and the second air chambers 4A and 4B are housed in a case (casing) 11. In the embodiment of FIG. 2C, the first air chamber 4A is arranged at the side of the vehicle body 100B of the vehicle 100 to which the vehicle-body supporting apparatus 1c is attached. The second air chamber 4B is arranged below the first air chamber 4A in a vertical direction. Here, “vertical direction” means a direction of application of gravity, whereas “below” means a side closer to the ground (direction shown by an arrow GN in FIG. 2C).

The first air chamber 4A and the second air chamber 4B arranged opposite of each other are placed so as to sandwich a load-transfer member 3A, which is a vibration input unit, therebetween. To the load-transfer member 3A, the lower arm 21L of the suspension system 20 (see FIG. 1A) is attached. The lower arm 21L runs through a through hole 12 formed in the case 11. The load-transfer member 3A transfers a force transmitted from the road surface via the lower arm 21L to the first air chamber 4A and the second air chamber 4B. The force transmitted further to the gaseous matter in the first air chamber 4A and the second air chamber 4B is absorbed and relieved by the compression of the gaseous matter in the first air chamber 4A. Thus, the force to be transmitted to the vehicle body 100B is relieved and supported. As can be seen from the above, when the load is applied to the vehicle-body supporting apparatus 1c₁ the first air chamber 4A and the second air chamber 4B undergo opposite volumetric changes. Specifically, when the volume of the first air chamber 4A decreases, the volume of the second air chamber 4B increases.

Further, as shown in FIG. 2C, a load supporting area S1, which is an area of a portion of the first air chamber 4A in contact with a first supporting portion CP₁ of the load-transfer member 3A, is larger than a load supporting area S2, which is an area of a portion of the second air chamber 4B in contact with a second supporting portion CP₂ of the load-transfer member 3A (S1>S2). Here, an appropriate ratio of S1 to S2 is approximately 2:1 to 10:1 (the same applies below). Therefore, a pressure-receiving area of the first air chamber 4A which receives the pressure from the load-transfer member 3A is larger than a pressure-receiving area of the second air chamber 4B which receives the pressure from the load-transfer member 3A.

Thus, a force F1 of the first air chamber 4A pushing the load-transfer member 3A is larger than a force F2 of the second air chamber 4B pushing the load-transfer member 3A. As a result, the vehicle-body supporting apparatus 1c alone can support the load transmitted from the lower arm 21L to the load-transfer member 3A without the need of a separate spring or an air spring for supporting the load. At the same time, the vehicle-body supporting apparatus 1c can damp the transmission of the vibrations of notch frequency to the vehicle body 100B by opening/closing the fluid-path opening/closing unit 8 at the notch frequency.

In the vehicle-body supporting apparatus 1c₁ the load-transfer member 3A is sandwiched between the first air chamber 4A and the second air chamber 4B arranged opposite to each other. Since the lower arm 21L penetrating the through hole 12 is attached to the load-transfer member 3A and moves through the through hole 12, the vehicle-body supporting apparatus 1c absorbs and relieves the shock. In conventional buffer apparatuses, a point of action of load is located outside the case. In the vehicle-body supporting apparatus 1c of the embodiment, the point of action of load transmitted from the lower arm 21L can be set within the case 11 of the vehicle-body supporting apparatus 1c. As a result, the entire length of the vehicle-body supporting apparatus 1c can be made shorter than in the conventional apparatuses. Thus, the suspension system as a whole using the vehicle-body supporting apparatus 1c of the embodiment can be made more compact.

Further, as shown in FIG. 2C, the vehicle-body supporting apparatus 1c includes the stopper member 19 inside the vehicle-body supporting apparatus 1c at a position opposite to the first supporting portion CP₁ of the load-transfer member 3A at the side where the vehicle is attached. The stopper member 19 is arranged inside the first air chamber 4A at the attachment side of the vehicle-body supporting apparatus 1c to the vehicle body 100B (i.e., inside the first air chamber 4A and a side opposite to the direction of action of gravity (i.e., direction of the arrow GN of FIG. 2C)).

The stopper member 19 may be arranged at the side of the first supporting portion CP₁ of the load-transfer member 3A, or may be arranged both at the side of the first supporting portion CP₁ and at the attachment side of the vehicle-body supporting apparatus 1c to the vehicle body 100B and inside the first air chamber 4A. In brief, the stopper member 19 can be arranged inside the case 11 of the vehicle-body supporting apparatus 1c and between the first supporting portion CP₁ of the load-transfer member 3A and the vehicle body 100B. The stopper member 19 is made of an elastic body and generates a repulsive force when compressed in a direction of action of the load-transfer member 3A (in other words, a direction of action of the vehicle-body supporting apparatus 1c). The stopper member 19 may be configured with, for example, elastic material such as rubber and resin, a helical spring, disc spring, and air spring.

Even when the air inside the first air chamber 4A comes out and the vehicle-body supporting apparatus 1c becomes incapable of supporting the sprung mass of the vehicle 100 with the air pressure in the vehicle-body supporting apparatus 1c₁ the vehicle-body supporting apparatus 1c can still support the sprung mass by the stopper member 19. Therefore, even when the air leaks out from the first air chamber 4A or the like, the stopper member 19 directly contacts with the first supporting portion CP₁ of the load-transfer member 3A so as to support the mass of the vehicle body 100B, whereby the vehicle body 100B can keep running at least at a low speed. As a result, even when the air leakage occurs in the air chamber, the vehicle can keep running slowly until arriving at the repair shop or the like. Thus, it is preferable to arrange the stopper member 19 for the enhancement of reliability of the vehicle 100 provided with the vehicle-body supporting apparatus 1c.

FIG. 2D is a schematic diagram of a structure of another buffer apparatus which is applicable to the suspension system according to the embodiment. A vehicle-body supporting apparatus 1d has a similar structure as that of the vehicle-body supporting apparatus 1c₁ however, in the vehicle-body supporting apparatus 1d, a load-transfer member 3B, which is a vibration input unit, penetrates through the first air chamber 4A and the second air chamber 4B arranged opposite to each other. The first supporting portion CP₁ of the load-transfer member 3B is brought into contact with the first air chamber 4A at an opposite side from an opposing surface OP. Further, the second supporting portion CP₂ of the load-transfer member 3B is brought into contact with the second air chamber 4B at an opposite side from an opposing surface OP. The load supporting area S1, which is an area of a portion of the first supporting portion CP₁ in contact with the first air chamber 4A, is larger than the load supporting area S2, which is an area of a portion of the second supporting portion CP₂ in contact with the second air chamber 4B. When the load is applied to the vehicle-body supporting apparatus 1d, the first air chamber 4A and the second air chamber 4B undergo opposite volumetric changes. Similarly to the vehicle-body supporting apparatuses 1, 1c₁ and the like described above, the vehicle-body supporting apparatus 1d can damp the transmission of the vibrations of notch frequency to the vehicle body 100B by opening/closing the fluid-path opening/closing unit 8 at the notch frequency.

FIG. 2E is a schematic diagram of another example of the configuration of the vehicle-body supporting apparatus according to the first embodiment. In a vehicle-body supporting apparatus 1e, one end (upper end) of an apparatus casing 2e is connected to the vehicle body 100B, and a bracket member 5e which extends in an opposite direction from the vehicle body 100B (i.e., extends downward) is connected to the lower arm 21L of the suspension system. In the vehicle-body supporting apparatus 1e, the first air chamber 4A and the second air chamber 4B are divided by flexible members 9A and 9B, respectively, so as to form a rolling-lobe air spring. The vehicle-body supporting apparatus 1e employs an air-chamber cover (second air-chamber cover) 3e of the second air chamber 4B as a vibration input unit. The air-chamber cover 3e is connected to the bracket member 5e. More specifically, the relative vibrations between the lower arm 21L and the vehicle body 100B are transmitted to the air-chamber cover 3e of the second air chamber 4B via the bracket member 5e. The air-chamber cover 3e of the second air chamber 4B of the vehicle-body supporting apparatus 1e has the function as the vibration input unit for the air chamber of the vehicle-body supporting apparatus, which is similar to the function of the piston 3 of the vehicle-body supporting apparatus 1 of FIG. 1A and the load-transfer member 3A of the vehicle-body supporting apparatus 1c of FIG. 2C.

The vehicle-body supporting apparatus 1c of FIG. 2C includes the first air chamber 4A and the second air chamber 4B arranged at positions facing the load-transfer member 3A, respectively, so as to stabilize the suspension system with the mutually pushing force of the first air chamber 4A and the second air chamber 4B. On the other hand, the vehicle-body supporting apparatus 1e of FIG. 2E obtains the similar effect as that of the vehicle-body supporting apparatus 1c of FIG. 2C by making the first air chamber 4A and the second air chamber 4B push the air-chamber cover 3e which is made integral with the bracket member 5e connected to the lower arm 21L of the suspension system. In the vehicle-body supporting apparatus 1e, the bracket member 5e and the air-chamber cover 3e of the second air chamber 4B serve as a vibration input unit. When the use efficiency of space is considered, the vehicle-body supporting apparatus 1e of FIG. 2E is more advantageous than the vehicle-body supporting apparatus 1c of FIG. 2C. Further, the vehicle-body supporting apparatus 1e of FIG. 2E is appropriate for a so-called strut-type suspension system.

In the vehicle-body supporting apparatus 1e, the first air chamber 4A and the second air chamber 4B are connected via the fluid path 7. The fluid-path opening/closing unit 8 is provided in the fluid path 7. The vehicle-body supporting apparatus 1e damps the transmission of vibrational components having the same frequency as the notch frequency by opening/closing the on-off valve 8V of the fluid-path opening/closing unit 8 at the notch frequency which is set corresponding to the characteristics of vibration detected by the vibration detector (for example, the vehicle-body acceleration sensor 30 and the suspension-system acceleration sensor 31; see FIG. 1A). Thus, the vehicle-body supporting apparatus 1e is advantageous in that the effect of vibration transmission damping is hardly deteriorated since the vehicle-body supporting apparatus 1e follows the characteristics of vibration that change over time.

FIG. 2F is a schematic diagram of still another example of the configuration of the vehicle-body supporting apparatus according to the first embodiment. A vehicle-body supporting apparatus if is similar to the vehicle-body supporting apparatus 1e of FIG. 2E, except that an inner wall surface of the first air chamber 4A is formed with an inner wall surface of an outer cylinder 2A, and that an inner wall surface of the second air chamber 4B is formed with an inner wall surface of an inner cylinder 3f. In a bottom portion 2AB of the outer cylinder 2A, a through hole 12 is formed. The inner cylinder 3f runs through the through hole 12.

Further, a flexible member 9A forming the first air chamber 4A is arranged between the outer cylinder 2A and the inner cylinder 3f, and a flexible member 9B forming the second air chamber 4B is arranged between the inner cylinder 3f and the bottom portion 2AB of the outer cylinder 2A. In the vehicle-body supporting apparatus if, the inner cylinder 3f and a bracket 5f connected to the inner cylinder 3f form a vibration input unit.

The vehicle-body supporting apparatus 1f includes a first stopper member 19A arranged at the attachment side of the vehicle body of the outer cylinder 2A, and a second stopper member 19B arranged at the bottom portion 2AB of the outer cylinder 2A. At the center of the first stopper member 19A and the second stopper member 19B, the fluid path 7 is formed to connect the first air chamber 4A and the second air chamber 4B. The fluid-path opening/closing unit 8 is provided in the fluid path 7. The vehicle-body supporting apparatus 1f damps the transmission of vibrational components having the same frequency as the notch frequency by opening/closing the on-off valve 8V provided in the fluid-path opening/closing unit 8 at the notch frequency which is set corresponding to the characteristics of vibration detected by the vibration detector (for example, the vehicle-body acceleration sensor 30 and the suspension-system acceleration sensor 31; see FIG. 1A). Thus, the vehicle-body supporting apparatus 1f is advantageous in that the effect of vibration transmission damping is hardly deteriorated since the vehicle-body supporting apparatus 1f follows the characteristics of vibration that change over time. The principle of the present invention is similarly applicable to air springs which have dynamically opposing relation and form a pair, even when the first air chamber 4A and the second air chamber 4B are not geometrically opposed to each other.

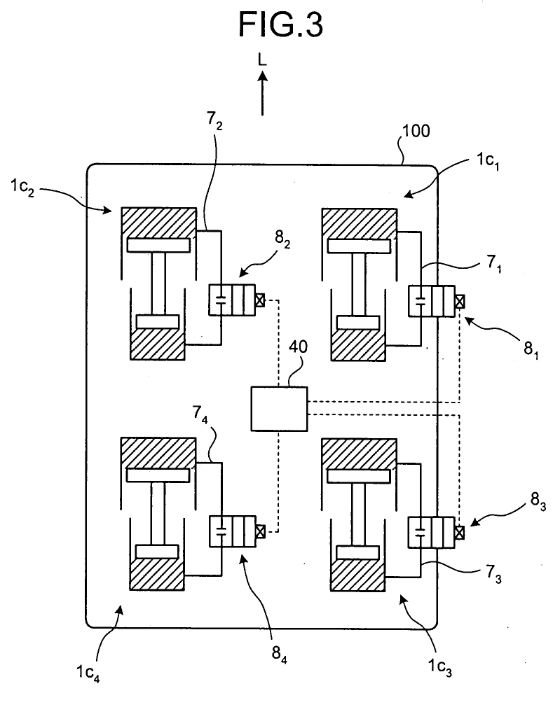

FIG. 3 is a conceptual diagram of the vehicle-body supporting apparatuses of the first embodiment arranged to a vehicle. FIG. 3 shows an example of the arrangement of the vehicle-body supporting apparatus 1c shown in FIG. 2C arranged to each of four wheels of the vehicle 100. An advancing direction of the vehicle 100 is shown by an arrow L of FIG. 3. Vehicle-body supporting apparatuses 1c₁, 1c₂, 1c₃, 1c₄ are arranged at positions of a right-side front wheel, a left-side front wheel, a right-side rear wheel, and a left-side rear wheel, respectively in the vehicle 100. The vehicle-body supporting apparatuses 1c₁, 1c₂, 1c₃, 1c₄ damp the transmission of vibrations of a specific frequency by opening/closing fluid-path opening/closing units 8₁, 8₂, 8₃, 8₄ provided in fluid paths 7₁, 7₂, 7₃, 7₄, respectively, at a specific frequency using the vibration damping control apparatus 40, as described above.

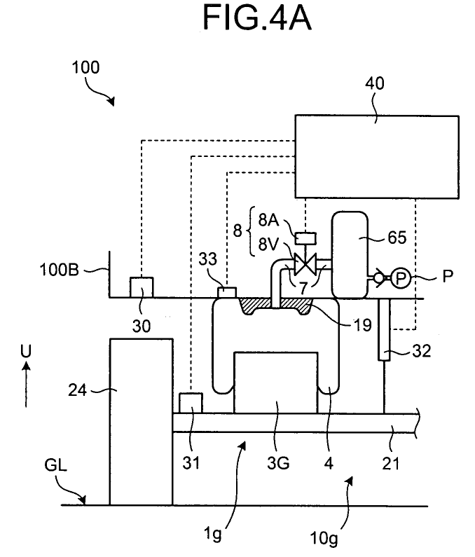

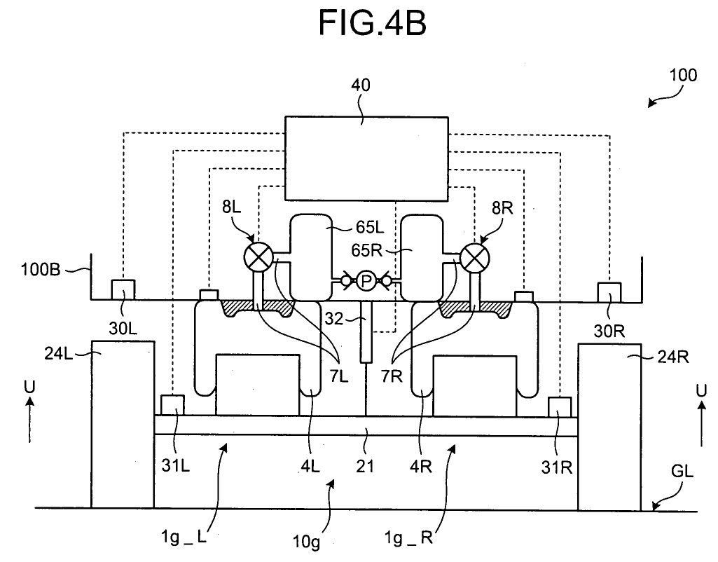

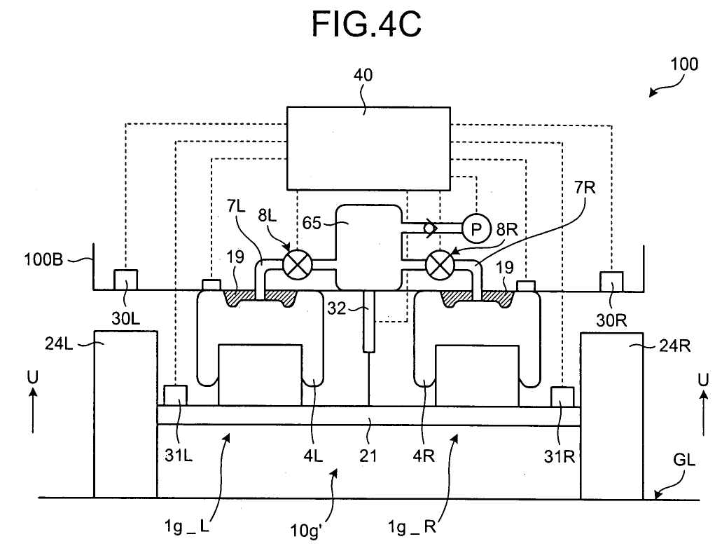

FIGS. 4A to 4C are schematic diagrams of still another example of the vehicle-body supporting apparatus according to the first embodiment and a vehicle-body supporting system including the same. FIG. 4A is a diagram of a portion supporting one wheel of the vehicle 100. FIG. 4B is a diagram of the vehicle-body supporting system according to the embodiment applied to the right and the left wheels of the vehicle 100. FIG. 4C is a diagram of a modification of the vehicle-body supporting system of the embodiment applied to the right and the left wheels of the vehicle 100.

The vehicle-body supporting apparatuses and the vehicle-body supporting systems shown in FIGS. 4A to 4C periodically open/close a fluid path connected to an air chamber that is filled with a gaseous matter such as air and nitrogen to support the load, release part of the gaseous matter filling the air chamber into an air storage chamber provided separately from the air chamber, and make a spring stiffness of the air chamber decrease with respect to an external force having the same period as the frequency of opening/closing operation of the fluid path, so as to utilize this characteristic. Thus, even when the natural frequency of the vibrating system varies, an effect of vibration damping can be exerted with respect to the supported mass (i.e., mass of the vehicle body).

A vehicle-body supporting system 10g supports the vehicle 100 of FIG. 4A. The vehicle-body supporting system 10g includes a vehicle-body supporting apparatus 1g arranged between the vehicle body 100B of the vehicle 10 and the wheel 24 of the vehicle 100. The vehicle-body supporting apparatus 1g is provided with an air chamber 4 which is filled with a gaseous matter. The vehicle-body supporting apparatus 1g supports the load of the vehicle body 100B by the pressure of the gaseous matter filling the air chamber 4.

The vehicle-body supporting apparatus 1g works as a buffer apparatus of the suspension system of the vehicle 100, in other words, as a structural body including a spring and a vibration attenuation unit (e.g., damper). In the embodiment, the structural body supported by the vehicle-body supporting apparatus 1g is the vehicle body 100B of the vehicle 100.

The vehicle-body supporting apparatus 1g includes the air chamber 4 filled with a gaseous matter (air in the embodiment) such as air or nitrogen, and a load-transfer member 3G in contact with the air chamber 4. In the embodiment, the air chamber 4 is formed with an elastic member such as rubber or an elastomer. The load-transfer member 3G serves as a vibration input unit which inputs at least one of the vibration from the vehicle body 100B and the vibration from the wheel 24 by reciprocating relative to the air chamber 4. A portion serves as the vibration input unit to transmit the vibrations from the wheel 24 to the air chamber 4 is the load-transfer member 3G, whereas a portion serves as the vibration, input unit to transmit the vibrations from the vehicle body 100B to the air chamber 4 is a connecting portion between the vehicle body 100B and the air chamber 4.

The load-transfer member 3G which is the vibration input unit of the vehicle-body supporting apparatus 1g is attached to an axle 21. One end of the axle 21 is fixed to the wheel 24. An input (such as a force in a direction of an arrow U in FIG. 4A, or vibrations) from the wheel 24 is transmitted to the load-transfer member 3G via the axle 21 and further to the air chamber 4. The input transmitted from the wheel 24 via the vehicle-body supporting apparatus 1g to the vehicle body 100B is relieved by the gaseous matter filling the air chamber 4. Thus, the vehicle-body supporting apparatus 1g works as an air spring so as to absorb the shocks applied to the wheel 24 from the road surface GL and to support the mass of the vehicle body 100B.

The vehicle-body supporting system 10g is provided with an air storage chamber 65 which stores a gaseous matter filling the air chamber 4 of the vehicle-body supporting apparatus 1g inside. The air chamber 4 of the vehicle-body supporting apparatus 1g and the air storage chamber 65 are connected via the fluid path 7. The fluid-path opening/closing unit 8 is arranged in the fluid path 7. The fluid-path opening/closing unit 8 includes the on-off valve 8V, and the actuator (e.g., solenoid, piezoelectric element, and ultrasonic motor) 8A which opens/closes the on-off valve 8V. The vibration damping control apparatus 40 controls operations of the actuator 8A.

As shown in FIG. 4A, the vehicle-body acceleration sensor 30 is attached to the vehicle body 100B of the vehicle 100. The vehicle-body acceleration sensor 30 can detect acceleration of the vehicle body 100B in a direction orthogonal to the road surface GL (i.e. acceleration of a portion of the vehicle 100 above the spring). Based on the detected acceleration, the frequency of the vibrations of the portion above the spring can be found. Further, the suspension-system acceleration sensor 31 is attached to the axle 21 to detect acceleration of the wheel 24 in a direction orthogonal to the road surface GL. Thus, the suspension-system acceleration sensor 31 detects the movements of the axle 21 so that the acceleration of the vehicle 100 under the spring in the direction orthogonal to the road surface GL can be found. Based on the found acceleration, the frequency of the vibrations of the vehicle 100 under the spring can be found.

Thus, each of the vehicle-body acceleration sensor 30 and the suspension-system acceleration sensor 31 works as a vibration detector. More specifically, the vehicle-body acceleration sensor 30 works as a sprung vibration detector which detects the vibrations of the portion of the vehicle 100 above the spring, whereas the suspension-system acceleration sensor 31 works as an unsprung vibration detector which detects the vibrations of a portion of the vehicle 100 under the spring.

Further, the stroke sensor 32 is attached to the axle 21. The stroke sensor 32 allows for the detection of the vehicle level of the vehicle 100. The stroke sensor 32 also provides information on the stroke of the vehicle-body supporting apparatus 1g. Therefore, the vehicle level of the vehicle 100 can be maintained at a fixed level through replenishment of air in the air chamber 4, or through the discharge of the air from the air chamber 4, when the passenger of the vehicle changes or the load of the vehicle 100 changes so as to cause the variations in vehicle level.

As shown in FIG. 4A, the vehicle-body supporting system 10g may be provided with the air-chamber pressure sensor 33 which measures pressure level in the air chamber 4. The pressure of the air spring is constant as far as the supported load and the load-supporting area are fixed. The air-chamber pressure sensor 33, however, can effectively detect an emergency condition such as damage to the air spring.

A pump P is connected to the air storage chamber 65. The pump P supplies a gaseous matter to the air storage chamber 65 thereby supplying the gaseous matter to the air chamber 4 via the air storage chamber 65. In brief, the pump P works as a fluid supply unit for the air chamber 4. When the amount of the gaseous matter in the air chamber 4 detected by the stroke sensor 32 which serves as an air-amount detector is equal to or below a predetermined threshold value, it can be considered as indicating that the vehicle-body supporting capability of the vehicle-body supporting apparatus 1g is decreasing. In this case, the gaseous matter is replenished to the air chamber 4 by the pump P. Thus, the vehicle-body supporting apparatus 1g can remain able to support the vehicle body 100B so as to realize safe running of the vehicle 100.

Further, the stopper member 19 is arranged inside the vehicle-body supporting apparatus 1g at a position opposite to the load-transfer member 3G at the attachment side of the vehicle body. The stopper member 19 can support the sprung mass even when the air in the air chamber 4 comes out to disable the supporting of the sprung mass of the vehicle 100 by the air pressure. Thus, even when the air leakage occurs in the air chamber 4, the stopper member 19 directly contacts with the load-transfer member 3G so as to support the mass of the vehicle body 100B. Therefore, the vehicle body 100B can run at least at low speed. As a result, even when the air leakage occurs in the air chamber 4, the vehicle 100 can run slowly until arriving at a repair shop or the like.

In the embodiment, the air chamber 4 and the air storage chamber 65 of the vehicle-body supporting apparatus 1g are connected with each other via the fluid path 7 through which the gaseous matter filling the air chamber 4 and the air storage chamber 65 passes. Further, the on-off valve 8V is provided in the fluid path 7 so as to form the fluid-path opening/closing unit 8. Specifically, the on-off valve 8V is arranged between the air chamber 4 and the air storage chamber 65. When the actuator 8A closes the on-off valve 8V, the air chamber 4 is cut off from the air storage chamber 65, so that the gaseous matter cannot move between the air chamber 4 and the air storage chamber 65. On the other hand, when the actuator 8A opens the on-off valve 8V, the air chamber 4 is communicated with the air storage chamber 65, so that the gaseous matter can move between the air chamber 4 and the air storage chamber 65 via the fluid path 7.

The vehicle-body supporting apparatus 1g damps the transmission of vibrations of a notch frequency to the vehicle body 100B by working as a notch filter which decreases the spring stiffness with respect to the vibrations of the notch frequency. Thus, the vehicle-body supporting apparatus 1g can avoid resonance amplification in the vibrating system of the vehicle 100 and prevent transmission of uncomfortable vibrations to the vehicle body 100B. As described above, the vehicle-body supporting apparatus 1g has an effect of damping the transmission of vibrations to the vehicle body 100B. In other words, the vehicle-body supporting apparatus 1g has an effect like a vibration attenuation apparatus.

The vibration damping control apparatus 40 controls the vehicle-body supporting apparatus 1g and the vehicle-body supporting system 10g. In the embodiment, sensors such as the vehicle-body acceleration sensor 30 and the suspension-system acceleration sensor 31 which serve for acquiring information necessary for the control of the vehicle-body supporting apparatus 1g and the vehicle-body supporting system 10g are connected to the vibration damping control apparatus 40. Further, the actuator 8A which controls the opening/closing operations of the on-off valve 8V of the fluid-path opening/closing unit 8, in other words, a control target necessary for the vibration control, is connected to the vibration damping control apparatus 40. With the above-described configuration, the vibration damping control apparatus 40 can open/close the on-off valve 8V of the fluid-path opening/closing unit 8 at a specific frequency according to output signals from the sensors so as to control the vehicle-body supporting apparatus 1g and the vehicle-body supporting system 10g according to the embodiment.

The vehicle-body supporting system 10g shown in FIG. 4B includes a first air storage chamber 65L corresponding to a first vehicle-body supporting apparatus 1g_L supporting a first wheel (left-side wheel) 24L and a second air storage chamber 65R corresponding to a second vehicle-body supporting apparatus 1g_R supporting a second wheel (right-side wheel) 24R. Thus, the first vehicle-body supporting apparatus 1g_L and the second vehicle-body supporting apparatus 1g_R are connected respectively to air storage chambers arranged separately.

An air chamber 4L of the first vehicle-body supporting apparatus 1g_L and the first air storage chamber 65L are connected via a first fluid path 7L, whereas an air chamber 4R of the second vehicle-body supporting apparatus 1g_R and the second air storage chamber 65R are connected via a second fluid path 7R. A first fluid-path opening/closing unit 8L is arranged in the first fluid path 7L, whereas a second fluid-path opening/closing unit 8R is arranged in the second fluid path 7R. The vibration damping control apparatus 40 controls each of the first fluid-path opening/closing unit 8L and the second fluid-path opening/closing unit 8R.

A first vehicle-body acceleration sensor 30L is arranged at a position corresponding to the first vehicle-body supporting apparatus 1g_L in the vehicle 100B, whereas a second vehicle-body acceleration sensor 30R is arranged at a position corresponding to the second vehicle-body supporting apparatus 1g_R. Each of the first and the second vehicle-body acceleration sensors 30L and 30R works as a sprung vibration detector which detects the vibrations of a portion of the vehicle 100 supported by the spring. The first and the second vehicle-body acceleration sensors 30L and 30R serve as measurement/control unit for the control of the vehicle-body supporting system 10g by the vibration damping control apparatus 40. A first suspension-system acceleration sensor 31L is arranged on the axle 21 at a position corresponding to the first vehicle-body supporting apparatus 1g_L, whereas a second suspension-system acceleration sensor 31R is arranged on the axle 21 at a position corresponding to the second vehicle-body supporting apparatus 1g_R. The first and the second suspension-system acceleration sensors 31L and 31R work as an unsprung vibration detector that detects the vibration of a portion of the vehicle 100 not supported by the spring. The first and the second suspension-system acceleration sensors 31L and 31R serve as a source of measurement and control for the control of the vehicle-body supporting system 10g by the vibration damping control apparatus 40.

The vehicle-body supporting system 10g shown in FIG. 4B finds a frequency of vibrations in a sprung portion of the vehicle 100 based on the accelerations acquired by the first and the second vehicle-body acceleration sensors 30L and 30R, for example, so as to extract a frequency of vibrations whose transmission to the vehicle body 100B is not desirable. Then, the vehicle-body supporting system 10g opens/closes at least one of the first fluid-path opening/closing unit 8L and the second fluid-path opening/closing unit 8R at the extracted frequency. Thus, the spring stiffness of the first vehicle-body supporting apparatus 1g_L or the second vehicle-body supporting apparatus 1g_R with respect to the extracted frequency decreases (in other words, gain of the first vehicle-body supporting apparatus 1g_L or the second vehicle-body supporting apparatus 1g_R for the extracted frequency approaches zero). As a result, the transmission of the vibrations of the extracted frequency to the vehicle body 100B is damped. Further, if a separate air storage chamber is prepared for each of the plural vehicle-body supporting apparatuses, there would be no interference between the vehicle-body supporting apparatuses, whereby the control precision of the vehicle-body supporting system 10g can be enhanced.

In a vehicle-body supporting system 10g′ shown in FIG. 4C, the first vehicle-body supporting apparatus 1g_L supporting the first wheel (left-side wheel) 24L and the second vehicle-body supporting apparatus 1g_R supporting the second wheel (right-side wheel) 24R are connected to the common air storage chamber 65.

The air chamber 4L of the first vehicle-body supporting apparatus 1g_L and the air storage chamber 65 are connected via the first fluid path 7L, whereas the air chamber 4R of the second vehicle-body supporting apparatus 1g_R and the air storage chamber 65 are connected via the second fluid path 7R. The first fluid-path opening/closing unit 8L is arranged in the first fluid path 7L, whereas the second fluid-path opening/closing unit 8R is arranged in the second fluid path 7R. The vibration damping control apparatus 40 controls each of the first fluid-path opening/closing unit 8L and the second fluid-path opening/closing unit 8R. Thus, when plural vehicle-body supporting apparatuses share the single air storage chamber, the number of air storage chambers can be decreased. Therefore, mountainability to the vehicle 100 can be enhanced and the total mass of the vehicle-body supporting system 10g′ can be reduced. In addition, manufacturing cost of the vehicle-body supporting system 10g′ can be reduced.

When plural vehicle-body supporting apparatuses share a single air storage chamber, all the vehicle-body supporting apparatuses included in the vehicle-body supporting system may share the air storage chamber, or a part of the vehicle-body supporting apparatuses share the air storage chamber. In the latter case: apparatuses corresponding to two wheels on the front side or two wheels on the rear side may share the air storage chamber; or apparatuses corresponding to two wheels on the right side or two wheels on the left side may share the air storage chamber; or apparatuses corresponding to two diagonally arranged wheels share the air storage chamber. Further, it is possible to arrange one air storage chamber shared by apparatuses corresponding to the right and the left rear wheels, one for the apparatus for the right front wheel, and one for the apparatus for the left front wheel. The vibration damping control apparatus 40 used for the control of the vehicle-body supporting apparatus according to the embodiment will be described below.

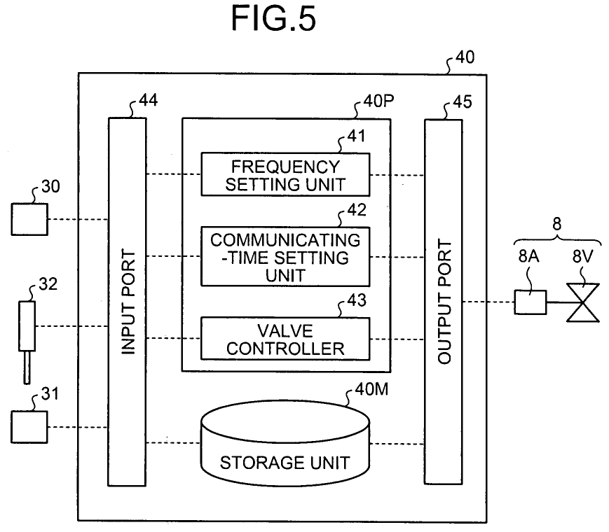

FIG. 5 is a schematic diagram of a configuration of the vibration damping control apparatus according to the first embodiment. The vibration damping control apparatus 40 includes a CPU (Central Processing Unit) 40P, a storage unit 40M, an input port 44, and an output port 45.

The CPU 40P of the vibration damping control apparatus 40 includes a frequency setting unit 41, a communicating-time setting unit 42, and a valve controller (fluid-path opening/closing unit controller) 43. These are the components performing the vibration control of the embodiment. The frequency setting unit 41, the communicating-time setting unit 42, and the valve controller 43 of the vibration damping control apparatus 40 are connected with each other via the input port 44 and the output port 45. Thus, the frequency setting unit 41, the communicating-time setting unit 42, and the valve controller 43 of the vibration damping control apparatus 40 are configured so as to be able to send control data with each other and to send command unilaterally.

Further, the CPU 40P and the storage unit 40M are connected via the input port 44 and the output port 45. Thus, the vibration damping control apparatus 40 can store data in the storage unit 40M, and utilize data, computer programs, and the like stored in the storage unit 40M.

Sensors such as the vehicle-body acceleration sensor 30 and the stroke sensor 32 which serve for acquiring information necessary for the control of the vehicle-body supporting apparatus 1 are connected to the input port 44. Thus, the CPU 40P can acquire necessary information for the control of the vehicle-body supporting apparatus 1. The output port 45 is connected to the actuator 8A which controls the opening/closing operations of the on-off valve 8V of the fluid-path opening/closing unit 8. The on-off valve 8V is a control target which must be controlled for the vibration control. With the above-described configuration, the CPU 40P can open/close the on-off valve 8V of the fluid-path opening/closing unit 8 at a specific frequency based on output signals provided from the sensors.

The storage unit 40M stores data, computer programs, and the like which include instructions on process procedures of vibration control according to the embodiment. The storage unit 40M may be configured with a volatile memory such as a RAM (Random Access Memory), a non-volatile memory such as a flash memory, or a combination thereof.

The computer program described above may allow the execution of the instruction on the procedure of the vibration control of the embodiment in combination with a computer program previously stored. Further, the vibration damping control apparatus 40 may realize the functions of the frequency setting unit 41, the communicating-time setting unit 42, and the valve controller 43 using a dedicated hardware in place of the computer program. A first control of the vehicle-body supporting apparatuses 1 to 1g of the embodiment will be described below.

### First Control

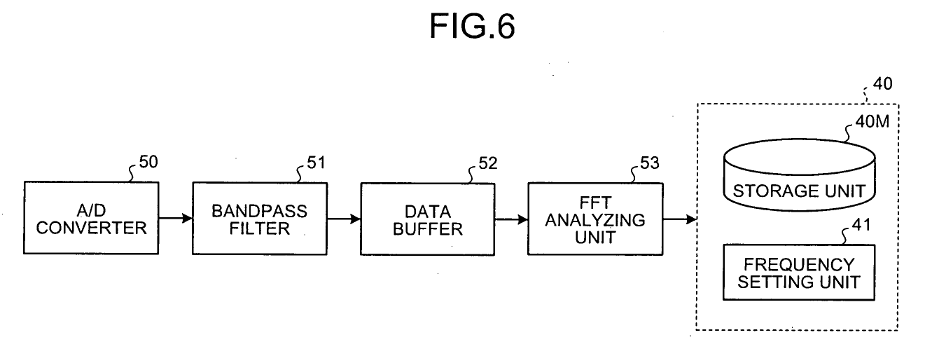

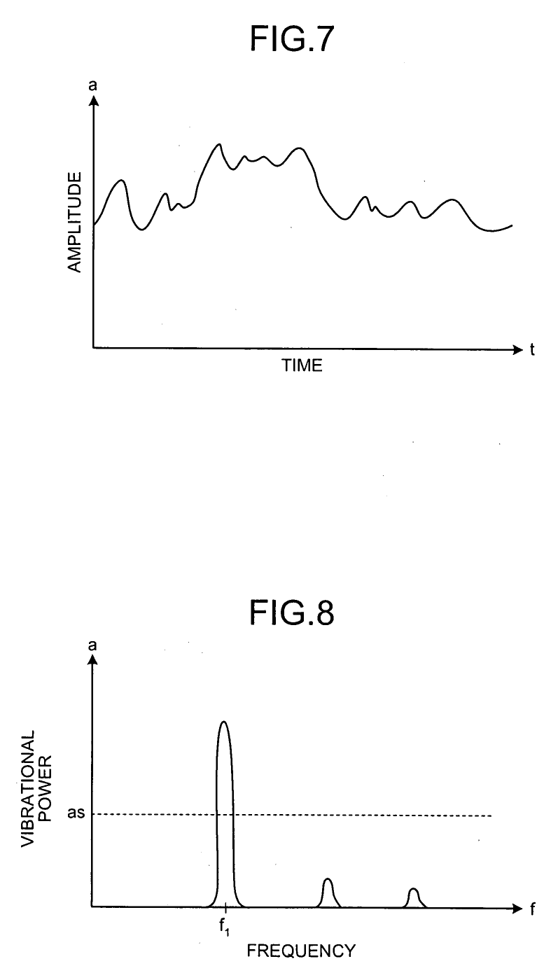

FIG. 6 is a functional block diagram of components performing Fourier analysis for the control of the vehicle-body supporting apparatus according to the first embodiment. FIGS. 7 to 10 are diagrams for explaining the first control of the vehicle-body supporting apparatus according to the first embodiment. As an example of the control of the vehicle-body supporting apparatus 1 of the embodiment, damping of vibrational components of a prominent frequency among vibrational components of the vehicle body 100B will be described below. The control described below is similarly applicable to the vehicle-body supporting apparatuses 1a, 1b, and the like of the embodiment.

For the execution of the first control of the vehicle-body supporting apparatus 1 of the embodiment, the frequency setting unit 41 identifies the frequency of vibrations whose transmission to the vehicle body 100B is to be damped (here, the identified frequency corresponds to the notch frequency mentioned earlier). In the embodiment, the frequency setting unit 41 acquires vibrational components of the vehicle body 100B based on the acceleration of the vehicle body 100B acquired by the vehicle-body acceleration sensor 30 (i.e., sprung acceleration). The acquired vibrations of the vehicle body 100B can be represented as FIG. 7, for example.

The damping of transmission of vibrations which have significant influence on the passenger of the vehicle is effective for damping the vibration transmitted from the road surface to the vehicle body 100B via the vehicle-body supporting apparatus 1 or the like and to provide a comfortable ride for the passenger of the vehicle 100. One manner of determining the level of influence to the passenger is to base the determination on a level of power spectrum. This manner of determination is based on an assumption that the vibrational component of high power dominates the vibrations as a whole and that the vibrational component of low power is not dominant in the vibrations as a whole. When the vibration whose transmission is to be damped is known (for example, is a natural frequency of a system including the portion of the vehicle 100 above the spring and the vehicle-body supporting apparatus 1), it is not necessary to determine the vibration whose transmission to the vehicle body 100B is to be damped. The “power” of the vibration means intensity (power) of each frequency when the input vibration is resolved into each frequency component. The power of vibration can be found as a sum of square of sinusoidal coefficient and square of cosine coefficient in the Fourier expansion.

To extract spectrum of high power, i.e., vibrational component which substantially dominates the vibration, from the time-changing vibrations, it is preferable to perform vibration analysis on real time. Here, “vibration analysis on real time” does not mean simultaneity in a narrow sense, but means that a series of operations of acquiring vibrations, sampling plural kinds of data of vibrations (e.g., amplitude, power, or energy) from the acquired vibrations at a predetermined time width, performing Fourier analysis, and extracting vibrational components of high-power spectrum is finished within a predetermined time and repeated.

As shown in FIG. 6, vibration signals from the vehicle-body acceleration sensor 30 (see FIG. 1A) are converted from an analog form to a digital form by an A/D (Analog-to-Digital) converter 50. The converted digital vibration signals are taken into a bandpass filter 51 and only the vibrational components of a predetermined frequency band pass through the bandpass filter 51.

When the transmission of vibrations, which makes the passenger of the vehicle 100 feel uncomfortable, to the vehicle body 100B is to be damped, a frequency band of vibrations of interest such as the frequency which the passenger feels uncomfortable, a sprung resonance frequency, an unsprung resonance frequency, and the like are already known. Therefore, the preparation is made to identify the frequency of vibration whose transmission to the vehicle body 100B is to be damped with the use of the bandpass filter 51 which passes the components of the known frequency band.

The vibrations of the frequency band passes through the bandpass filter 51 are temporarily stored in a data buffer 52. When the frequency setting unit 41 of the vibration damping control apparatus 40 supplies trigger signals indicating the end of analysis of previous data to the data buffer 52, the vibrations of the above-mentioned frequency band stored in the data buffer 52 are sent to an FFT (Fast Fourier Transform) analyzing unit 53 for Fourier analysis. FIG. 8 shows an example of the result of Fourier analysis of vibrations of the vehicle body 100B of FIG. 7.

The FFT analyzing unit 53 converts the vibration of the specific frequency band from a time region into a frequency region. The converted vibration is stored in the storage unit 40M of the vibration damping control apparatus 40. The frequency setting unit 41 determines the frequency of vibration whose transmission is to be damped based on the result of Fourier analysis stored in the storage unit 40M, in other words, based on the power spectrum. In the embodiment, the frequency of vibration whose transmission is to be damped is a frequency whose vibrational power (or amplitude, or energy) exceeds a predetermined threshold “as”, and is frequency f₁ in the example shown in FIG. 8.

After the frequency setting unit 41 identifies the frequency for the transmission damping, the vibration damping control apparatus 40 executes processing for damping the transmission of vibration of the identified frequency to the vehicle body 100B as described later. After the execution of the processing, the frequency setting unit 41 sends a command to the FFT analyzing unit 53 for executing Fourier analysis by acquiring the next data from the data buffer 52. In the embodiment, the above processing is executed repeatedly to detect the frequency of vibration which has a significant influence on the passenger and to control the vehicle-body supporting apparatus 1 or the like to damp the transmission of vibration of the detected frequency.

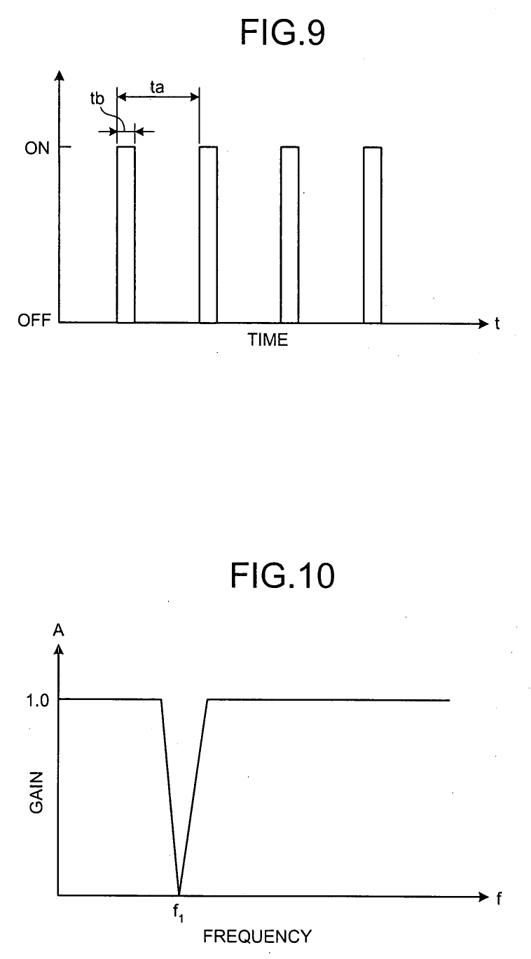

After identifying the frequency of vibration whose transmission is to be damped, the frequency setting unit 41 sets the frequency of vibration whose transmission is to be damped or an integral multiple thereof as the opening/closing frequency fo of the fluid-path opening/closing unit 8. FIG. 9 shows an example of the valve-opening command pulse. As shown in FIG. 9, the valve-opening command pulse has the pulse period of ta. When the valve is to be opened/closed at the identified frequency for transmission damping, the expression fo=f₁=(1/ta) is satisfied. Further, the communicating-time setting unit 42 sets the pulse width tb of the valve-opening command pulse based on the sustained load of the vehicle-body supporting apparatus 1 (see FIG. 9). The pulse width tb of the valve-opening command pulse indicates the time the on-off valve 8V remains open, i.e., the communicating time of the fluid path 7 (hereinafter referred to as valve-opening time). It is preferable that the valve-opening time tb be changed according to the level of the vibrational power of the vibration having the frequency whose transmission is to be damped. For example, the valve-opening time tb is made longer as the vibrational power of the vibration having the frequency for transmission damping increases. Then, the gain at the frequency for transmission damping can be made close to zero, whereby the transmission of the frequency can be damped more securely. Alternatively, the valve-opening time tb may be shortened as the sustained load of the vehicle-body supporting apparatus 1 increases, for example.

The valve controller 43 supplies the valve-opening command pulse to the actuator 8A of the fluid-path opening/closing unit 8 at the opening/closing frequency fo set by the frequency setting unit 41 with the pulse width set to the valve-opening time tb set by the communicating-time setting unit 42. Then as shown in FIG. 10, the vehicle-body supporting apparatus 1 works as a frequency filter having a gain of zero at the frequency f₁ whose transmission is to be damped, and having a gain of approximately 1.0 for frequencies other than the frequency f₁. Thus, the vibration of frequency f₁ whose transmission is to be damped is blocked by the vehicle-body supporting apparatus 1 and would not be transmitted to the vehicle body 100B substantially. Thus, the vibration having the frequency f₁ transmitted to the vehicle body 100B can be damped. When the frequency f₁ for transmission damping is set to the resonance frequency of the vehicle body 100B supported by the vehicle-body supporting apparatus 1, the resonance amplification can be avoided.

### Second Control

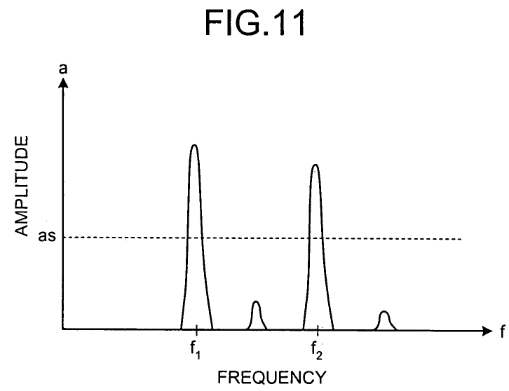

FIGS. 11 to 14 are graphs for explaining a second control of the vehicle-body supporting apparatus of the first embodiment. In the following, as an example of the control procedure of the vehicle-body supporting apparatus 1, 1a, or the like of the embodiment, transmission damping of vibrational components of the plural prominent frequency (two frequencies in this example) among the vibrational components of the vehicle body 100B will be described. In this case, the frequency setting unit 41 sets the frequency of vibration whose transmission to the vehicle body 100B is to be damped (which corresponds to the notch frequency mentioned earlier). The frequency setting unit 41 utilizes the storage unit 40M in which the result of Fourier analysis of the vibrational components of the vehicle body 100B are stored. Result of Fourier analysis is shown in FIG. 11. In the embodiment, the frequency of vibration whose transmission is to be damped is a frequency whose vibrational power (or amplitude, or energy) exceeds a predetermined threshold “as”, and is frequencies f₁ and f₂ in the example shown in FIG. 11.

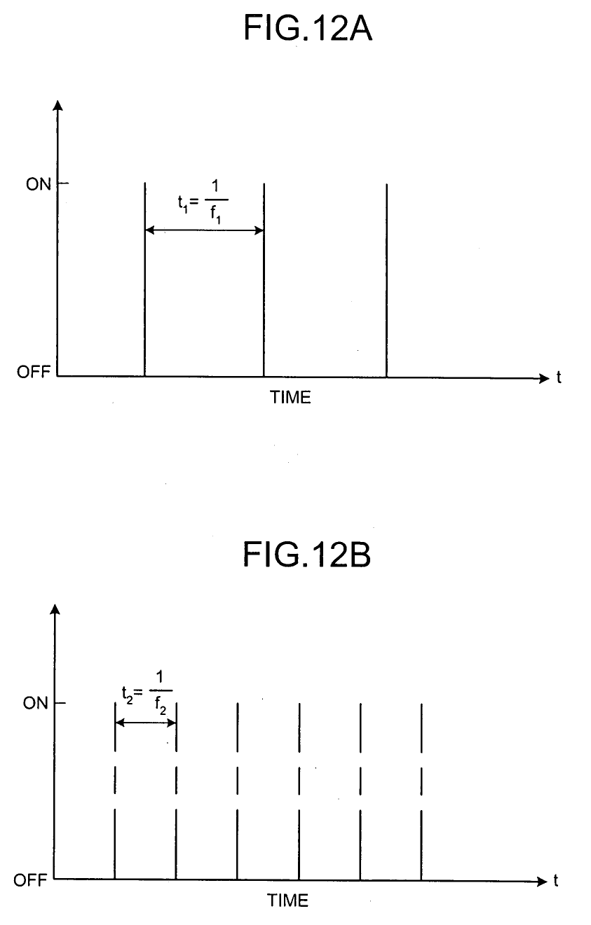

After identifying the frequency for the transmission damping, the frequency setting unit 41 sets the valve-opening command pulse for the fluid-path opening/closing unit 8. An example of the valve-opening command pulse is shown in FIGS. 12A and 12B. FIG. 12A shows a valve-opening command pulse for the frequency f₁ for transmission damping, whereas FIG. 12B shows a valve-opening command pulse for the frequency f₂ for transmission damping. As shown in FIG. 12A, the period of the valve-opening command pulse corresponding to the frequency f₁ for transmission damping is t₁ and the expression f₁=(1/t₁) is satisfied. Further, the period of the valve-opening command pulse corresponding to the frequency f₂ for transmission damping is t₂, and the expression f₂=(1/t₂) is satisfied.

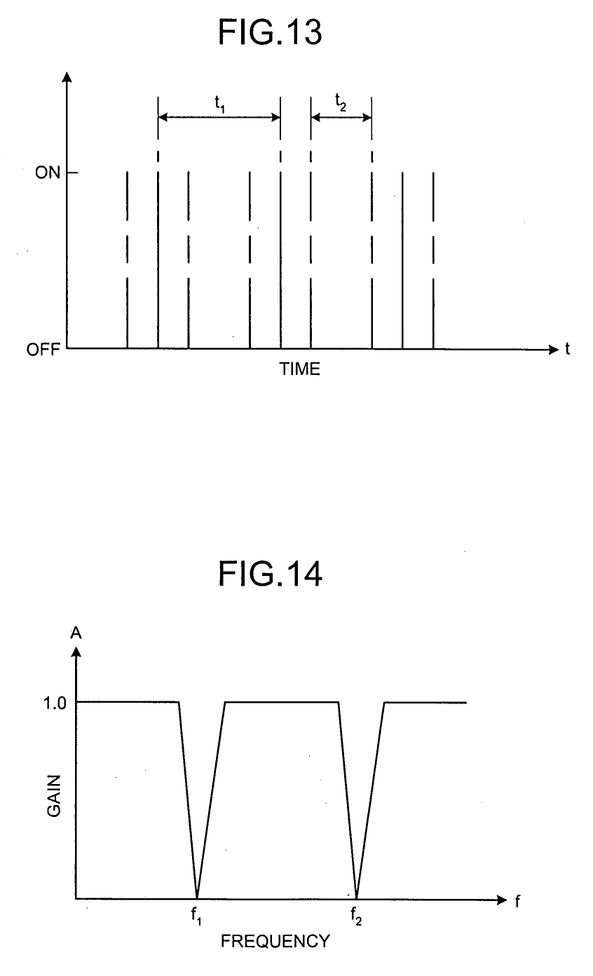

When there are plural frequencies whose transmission is to be damped, and vibrational components of these plural frequencies are to be handled, the frequency setting unit 41 employs a superposition of the valve-opening command pulse for the notch frequency f₁ and the valve-opening command pulse for frequency f₂ as the valve-opening command pulse sequence as shown in FIG. 13. Here, a solid line in FIG. 13 indicates the valve-opening command pulse for the frequency f₁ for transmission damping, and a dashed line indicates the valve-opening command pulse for the frequency f₂ for transmission damping.

The valve controller 43 supplies the valve-opening command pulse sequence set by the frequency setting unit 41 to the actuator 8A of the fluid-path opening/closing unit 8 with the pulse width set to the valve-opening time tb set by the communicating-time setting unit 42 (see FIG. 9). Then, as shown in FIG. 14, the vehicle-body supporting apparatus 1 works' as a frequency filter having a gain of zero at the frequencies f₁ and f₂ whose transmission is to be damped, and having a gain of approximately 1.0 for frequencies other than the frequencies f₁ and f₂. In other words, the vibrations of the frequencies f₁ and f₂ whose transmission is to be damped are blocked by the vehicle-body supporting apparatus 1 and would not be transmitted to the vehicle body 110B substantially.

When one of the plural frequencies whose transmission is to be damped is set to the resonance frequency of the vibrating system of the vehicle 100, the resonance amplification can be avoided. In the buffer apparatus configured with a spring and an oil damper, the vibration blocking characteristic deteriorates in a high frequency region. The vehicle-body supporting apparatus 1 of the embodiment can block plural types of vibrations simultaneously by setting the plural frequencies for transmission damping. Therefore, the transmission of vibrations to the vehicle body 100B can be damped in a wider frequency band.

In the above, the damping of sprung vibrations of the vehicle 100 by the vehicle-body supporting apparatus 1 and the like is described by way of example. The vehicle-body supporting apparatus 1 and the like of the embodiment, however, are similarly applicable to the damping of the unsprung vibration of the vehicle 100. In this case, the suspension-system acceleration sensor 31 detects the unsprung vibration of the vehicle 100 instead of the vehicle-body acceleration sensor 30 which detects the vibration of the vehicle body 100B (i.e., sprung vibration of the vehicle 100). The fluid-path opening/closing unit 8 is made to open/close at the notch frequency determined based on the unsprung vibrations detected. Thus, the transmission of the unsprung vibration of the frequency which affects the comfort of the passenger to the vehicle body 100B can be damped, whereby the ride quality of the vehicle 100 can be enhanced. Further, when the unsprung frequency which deteriorates the followability of the wheel 24 with respect to the road surface GL is set as the notch frequency, the deterioration of followability of the wheel 24 with respect to the road surface can be suppressed.

Further, in the above example, the frequency of the vibration whose transmission is to be damped is determined based on the sprung vibration or the unsprung vibration of the vehicle 100 as detected by the vibration detector. Alternatively, however, the frequency of the vibration whose transmission is to be damped may be fixed. For example, the frequency of the vibration whose transmission is to be damped may be set to the natural frequency of the vibrating system of the vehicle 100, and the fluid-path opening/closing unit 8 may be opened/closed constantly at a frequency corresponding to the natural frequency. Then, the fluid-path opening/closing unit 8 can be easily controlled. Further, as the natural frequency changes according to the changes in passenger and load, the frequency of the vibration whose transmission is to be damped may be changed according to the result of detection of changes in the natural frequency by the vibration detector.

The exemplary application of the vehicle-body supporting apparatus 1 of the embodiment to the suspension system of the vehicle is described. The application of the vehicle-body supporting apparatus 1 of the embodiment, however, is not limited thereto. The vehicle-body supporting apparatus 1 of the embodiment is applicable to any vehicles in which the transmission of vibration of notch frequency needs to be damped. The vehicle-body supporting apparatus 1 of the embodiment can be applied, for example, to suspension systems of general vehicles such as bicycles, two-wheel vehicles, trucks, and buses, general railroad vehicles such as trains and locomotives, buffer systems such as yaw dampers employed for railroad vehicle, steering dampers for two-wheel vehicles, shock absorbers for wheels of airplanes.

As can be seen from the foregoing, the apparatus of the embodiment includes an air chamber filled with gaseous matter such as air and nitrogen, and a vibration input unit which inputs vibration to the air chamber by reciprocating relative to the air chamber. A fluid path connected to the air chamber is opened/closed at a frequency for transmission damping (i.e., notch frequency) set corresponding to a frequency of reciprocation of the vibration input unit relative to the air chamber. With the above described configuration, the vibration of the frequency for transmission damping is blocked by the vehicle-body supporting apparatus, and would not be transmitted to the structural object supported by the vehicle-body supporting apparatus substantially. When the natural frequency of the vibrating system including the vehicle-body supporting apparatus and the mass supported thereby changes, the frequency for opening/closing the fluid path connected to the air chamber is changed according to the changes in the vibrational characteristics, whereby the effect of vibration transmission damping with respect to the supported mass can be exerted and the static load remains properly supported. Further, when the frequency for transmission damping is set based on the unsprung vibration of the vehicle, the deterioration in followability of the wheel with respect to the road surface can be suppressed.

### Second Embodiment

A second embodiment is characterized in that: each of two vehicle-body supporting apparatuses forming a pair supports the load by a first and a second air chambers provided therein; a first and a second fluid paths are provided to communicate the first and the second air chambers with each other; and a fluid-path opening/closing unit that opens/closes at a predetermined frequency is arranged in a third fluid path connecting the first and the second fluid paths with each other. In the following description, the vehicle-body supporting apparatus 1c (see FIG. 2C) described in the above description of the first embodiment will be used as an example. In the second embodiment, however, other vehicle-body supporting apparatuses mentioned in the description of the first embodiment are similarly applicable. In the following, “right” and “left” of the vehicle means the right and the left of the vehicle when facing the advancing direction of the vehicle. Further, “front” and “rear” of the vehicle means the front and the rear of the vehicle with reference to the advancing direction of the vehicle.

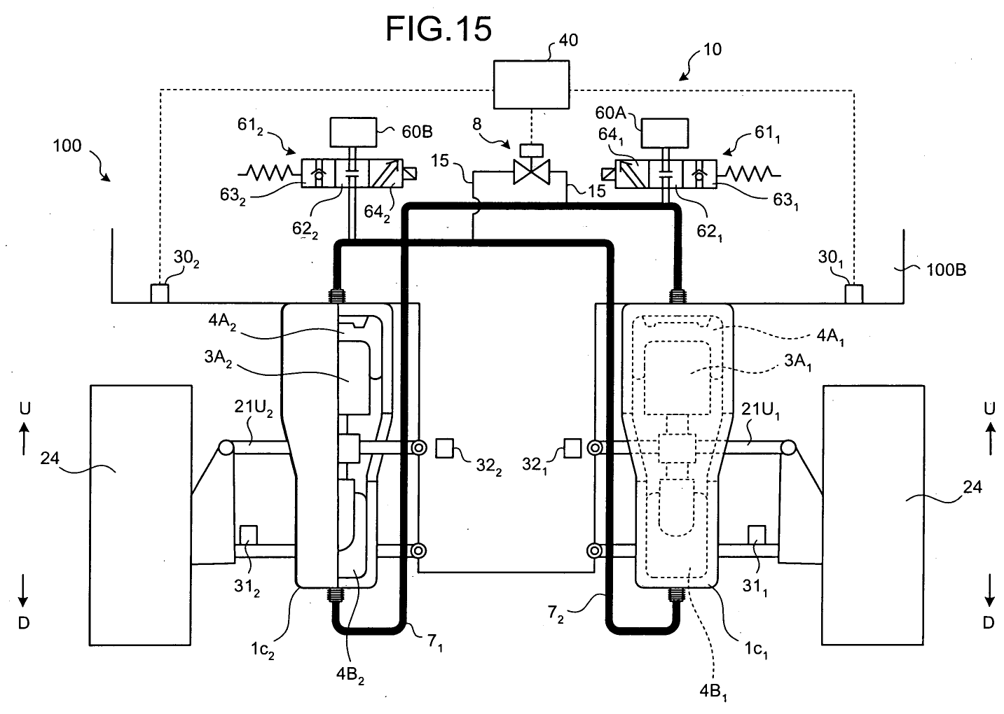

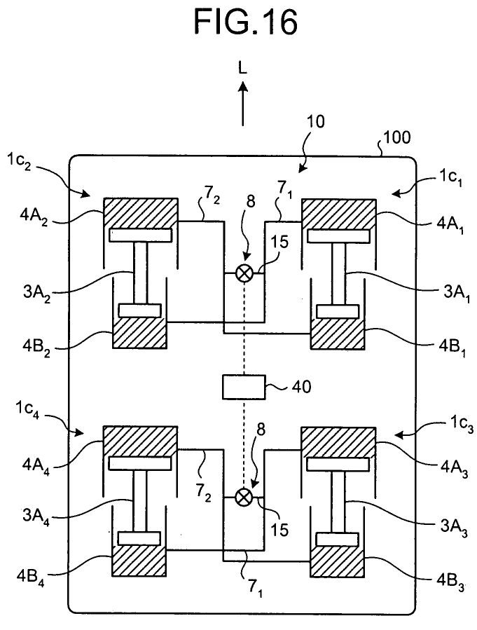

FIG. 15 is a schematic diagram of a piping arrangement in a vehicle-body supporting system according to the second embodiment. FIG. 16 is a schematic diagram of an example of connection between air chambers provided in vehicle-body supporting apparatuses on the right and the left sides of the vehicle in the vehicle-body supporting system according to the second embodiment. A direction indicated by an arrow L in FIG. 16 represents the advancing direction of the vehicle 100. In FIG. 16, vehicle-body supporting apparatuses 1c₁ to 1c₄ are shown in plan view. To facilitate the understanding of the piping arrangement, the vehicle-body supporting apparatuses 1c₁ to 1c₄ are shown as arranged horizontally to a paper surface, though actually arranged in a vertical direction.

FIG. 15 shows the vehicle-body supporting system 10 which corresponds to a configuration of a front portion of the vehicle 100 shown in FIG. 16. The vehicle-body supporting apparatus 1c provided in the vehicle-body supporting system 10 of FIG. 16 has the same configuration as the vehicle-body supporting apparatus 1c of the vehicle-body supporting system 10 of FIG. 15. The vehicle-body supporting system 10 of the second embodiment includes a pair of vehicle-body supporting apparatuses, i.e., a first vehicle-body supporting apparatus 1c₁ and a second vehicle-body supporting apparatus 1c₂ (these are referred to as the vehicle-body supporting apparatus 1c as necessary). The first vehicle-body supporting apparatus 1c₁ is arranged to the right of the advancing direction of the vehicle 100 (i.e., the direction of the arrow L of FIG. 16), whereas the second vehicle-body supporting apparatus 1c₂ is arranged to the left of the advancing direction of the vehicle 100. Thus, the first and the second vehicle-body supporting apparatuses 1c₁ and 1c₂ are arranged at different positions (the right and the left in the example) in the vehicle 100 so as to absorb and relieve an input the wheels 24 receive from the road surface. In a suspension system provided in the vehicle 100, upper arms 21U₁ and 21U₂ are fixed and connected to first and second vibration input units 3A₁ and 3A₂, respectively, as arms guiding the wheels 24 upward and downward.

A first air chamber 4A₁ of the first vehicle-body supporting apparatus 1c₁ and a second air chamber 4B₂ of the second vehicle-body supporting apparatus 1c₂ are connected via a first fluid path 7₁. Further, a second air chamber 4B₁ of the first vehicle-body supporting apparatus 1c₁ and a first air chamber 4A₂ of the second vehicle-body supporting apparatus 1c₂ are connected via a second fluid path 7₂. Thus, the first air chamber of one vehicle-body supporting apparatus communicates with the second air chamber of another vehicle-body supporting apparatus via the first fluid path 7₁ and the second fluid path 7₂.

The first fluid path 7₁ and the second fluid path 7₂ are connected via a third fluid path 15. The fluid-path opening/closing unit 8 is arranged in the third fluid path 15. The vibration damping control apparatus 40 opens/closes the fluid-path opening/closing unit 8 at a predetermined frequency (such as vibrations which give uncomfortable feeling to the passenger) so as to damp the transmission of the vibration of the predetermined frequency to the vehicle body 100B. Thus, the fluid-path opening/closing unit 8 decreases the spring stiffness of the first vehicle-body supporting apparatus 1c₁ and the second vehicle-body supporting apparatus 1c₂ semi-actively solely with respect to the predetermined frequency, whereby the transmission of the vibrations of the predetermined frequency to the vehicle body 100B is damped. Thus, even when the natural frequency of the vibrating system including the vehicle-body supporting apparatus 1c and the mass of the vehicle body 100B supported thereby changes, the vehicle-body supporting system 10 can exert the vibration damping effect on the vehicle body 100B while supporting the load of the vehicle body 100B.

The damping of the vibration transmission of a predetermined frequency can be realized by opening/closing the fluid-path opening/closing unit 8 in accordance with the input of the vibrations whose transmission is to be damped. For example, each piece of vibration data transmitted from four vibration detectors, i.e., a first vehicle-body acceleration sensor 30₁, a second vehicle-body acceleration sensor 30₂, a first suspension-system acceleration sensor 31₁, and a second suspension-system acceleration sensor 31₂, is frequency-resolved. Then, when the vibration with the maximum power is identified, the fluid-path opening/closing unit 8 is opened/closed at the frequency of the identified vibration. Thus, the transmission of the pertinent vibrational component to the vehicle body 100B can be damped. Here, the fluid-path opening/closing units 8 may be opened/closed simultaneously or at different times.

When the fluid-path opening/closing unit 8 is opened, the first fluid path 7₁ communicates with the second fluid path 7₂, and the gaseous matter therein is integrated in a closed space. The first fluid path 7₁ connects the first air chamber 4A₁ of the first vehicle-body supporting apparatus 1c₁ and the second air chamber 4B₂ of the second vehicle-body supporting apparatus 1c₂, whereas the second fluid path 7₂ connects the second air chamber 4B₁ of the first vehicle-body supporting apparatus 1c₁ and the first air chamber 4A₂ of the second vehicle-body supporting apparatus 1c₂. When the fluid-path opening/closing unit 8 is opened/closed at the frequency of the identified vibration, the vibrations of the identified frequency is received by the gaseous matter in all four air chambers, whereby the spring stiffness of the first vehicle-body supporting apparatus 1c₁ and the second vehicle-body supporting apparatus 1c₂ decreases with respect to a minute high-frequency vibration.

Operation corresponding to a quasi-static transition will be described. Constant of spring is higher when the first vehicle-body supporting apparatus 1c₁ and the second vehicle-body supporting apparatus 1c₂ operate in opposite phases, than when the first vehicle-body supporting apparatus 1c₁ and the second vehicle-body supporting apparatus 1c₂ operate in the same phase (in this embodiment, the constant is approximately double). Here, “operate in opposite phases” refers to, for example, a case where the first vibration input unit 3A₁ of the first vehicle-body supporting apparatus 1c₁ moves in an upward direction (i.e., to an attachment side of the vehicle body 100B indicated by an arrow U), whereas the second vibration input unit 3A₂ of the second vehicle-body supporting apparatus 1c₂ moves in a downward direction (to an opposite side from the attachment side of the vehicle 100 indicated by an arrow D). On the other hand, “operate in the same phase” refers to, for example, a case where the first vibration input unit 3A₁ of the first vehicle-body supporting apparatus 1c₁ and the second vibration input unit 3A₂ of the second vehicle-body supporting apparatus 1c₂ both move in the upward direction or in the downward direction.

For example, when the first vehicle-body supporting apparatus 1c₁ descends relative to the first vibration input unit 3A₁ of the first vehicle-body supporting apparatus 1c₁, the volume of the first air chamber 4A₁ of the first vehicle-body supporting apparatus 1c₁ decreases while the volume of the second air chamber 4B₁ increases. Since the first air chamber 4A₁ of the first vehicle-body supporting apparatus 1c₁ communicates with the second air chamber 4B₂ of the second vehicle-body supporting apparatus 1c₂, the gaseous matter pushed out from the first air chamber 4A₁ of the first vehicle-body supporting apparatus 1c₁ due to the decrease in volume thereof moves to the second air chamber 4B₂ of the second vehicle-body supporting apparatus 1c₂. In addition, since the second air chamber 4B₁ of the first vehicle-body supporting apparatus 1c₁ communicates with the first air chamber 4A₂ of the second vehicle-body supporting apparatus 1c₂, the gaseous matter tends to flow from the first air chamber 4A₂ of the second vehicle-body supporting apparatus 1c₂ due to the increase in volume of the second air chamber 4B₁ of the first vehicle-body supporting apparatus 1c₁.

When the first vehicle-body supporting apparatus 1c₁ and the second vehicle-body supporting apparatus 1c₂ operate in opposite phases, if the first vibration input unit 3A₁ of the first vehicle-body supporting apparatus 1c₁ moves in the upward direction of the first air chamber 4A₁, the first vibration input unit 3A₂ of the second vehicle-body supporting apparatus 1c₂ moves in the downward direction of the first air chamber 4A₁. Then, the volume of the second air chamber 4B₂ of the second vehicle-body supporting apparatus 1c₂ decreases so as to push out the gaseous matter toward the first air chamber 4A₁ of the first vehicle-body supporting apparatus 1c₁. On the other hand, the volume of the first air chamber 4A₂ of the second vehicle-body supporting apparatus 1c₂ increases so as to let in the gaseous matter from the second air chamber 4B₁ of the first vehicle-body supporting apparatus 1c₁.

When the first vehicle-body supporting apparatus 1c₁ and the second vehicle-body supporting apparatus 1c₂ operate in opposite phases, the movements of the gaseous matter between the first air chamber 4A₁ of the first vehicle-body supporting apparatus 1c₁ and the second air chamber 4B₂ of the second vehicle-body supporting apparatus 1c₂, and between the second air chamber 4B₁ of the first vehicle-body supporting apparatus 1c₁ and the first air chamber 4A₂ of the second vehicle-body supporting apparatus 1c₂ are prevented. As a result, in the vehicle-body supporting system 10 of the second embodiment, when the first vehicle-body supporting apparatus 1c₁ and the second vehicle-body supporting apparatus 1c₂ operate in the opposite phases, the constant of spring of each of the first vehicle-body supporting apparatus 1c₁ and the second vehicle-body supporting apparatus 1c₂ increases.

On the other hand, when the first vehicle-body supporting apparatus 1c₁ and the second vehicle-body supporting apparatus 1c₂ operate in the same phase, the movements of the gaseous matter between the first air chamber 4A₁ of the first vehicle-body supporting apparatus 1c₁ and the second air chamber 4B₂ of the second vehicle-body supporting apparatus 1c₂, and between the second air chamber 4B₁ of the first vehicle-body supporting apparatus 1c₁ and the first air chamber 4A₂ of the second vehicle-body supporting apparatus 1c₂ are enhanced. As a result, in the vehicle-body supporting system 10 of the second embodiment, when the first vehicle-body supporting apparatus 1c₁ and the second vehicle-body supporting apparatus 1c₂ operate in the same phase, the constant of spring of each of the first vehicle-body supporting apparatus 1c₁ and the second vehicle-body supporting apparatus 1c₂ decreases, whereby the ride quality is improved.

Here, the case where the first vehicle-body supporting apparatus 1c₁ and the second vehicle-body supporting apparatus 1c₂ operate in the same phase corresponds to a case where the vehicle 100 advances straight ahead. On the other hand, the case where the first vehicle-body supporting apparatus 1c₁ and the second vehicle-body supporting apparatus 1c₂ operate in the opposite phases corresponds to a case where the vehicle 100 takes a turn. In the vehicle-body supporting system 10 of the second embodiment, the spring constant increases when the first vehicle-body supporting apparatus 1c₁ and the second vehicle-body supporting apparatus 1c₂ operate in the opposite phases. Thus, a high ride quality can be secured with a low spring constant when the vehicle 100 moves straight forward, while roll stiffness can be improved with a high spring constant when the vehicle 100 takes a turn, whereby driving stability and driving performance at the turning of the vehicle 100 can be improved. Thus, the vehicle-body supporting system 10 can easily modify the spring constant of the buffer apparatus according to the driving condition of the vehicle 100 so as to provide both a high ride quality and the driving stability at the turning. In addition, the vehicle-body supporting system 10 can damp the undesirable vibration transmission to the vehicle body 100B by opening/closing the fluid-path opening/closing unit 8 at the frequency of the pertinent vibration so as to suppress the deterioration in ride quality.

Further, the vehicle-body supporting system 10 can provide a comfortable ride by damping the vibration transmission to the vehicle body 100B which gives uncomfortable feeling to the passenger by opening/closing the fluid-path opening/closing unit 8 at the vibration which gives uncomfortable feeling to the passenger, for example. Such effect can be realized even while the vehicle 100 is turning. Still further, the vehicle-body supporting system 10 can realize stable turning of the vehicle 100 by opening/closing the fluid-path opening/closing unit 8 at the same frequency as that of the vibrations in the roll direction of the vehicle 100 so as to damp the vibration transmission in the roll direction of the vehicle 100.

The vehicle-body supporting system 10 of the second embodiment, in which the first air chamber and the second air chamber respectively provided in different vehicle-body supporting apparatuses forming a pair communicate with each other, works similarly to a mechanical stabilizer for the vehicle roll when the vehicle 100 is turning. Therefore, the vehicle-body supporting system 10 can provide the same effect as a system with the stabilizer even without the mechanical stabilizer for the vehicle roll. As a result, a mechanical stabilizer is not necessary, which contributes to the weight saving of the system.

When a system is provided with a mechanical stabilizer with a high torsional stiffness to enhance the roll stiffness, if wheels of one side pass over a step, the ride quality may be deteriorated or there may be a negative effect on the driving stability. The vehicle-body supporting system 10 of the second embodiment, however, decreases the spring constant when the first vehicle-body supporting apparatus 1c₁ and the second vehicle-body supporting apparatus 1c₂ operate in the same phase, whereby the deterioration of drive quality and the negative influence on the driving stability can be suppressed.

Further, the vehicle-body supporting system 10 of the second embodiment shown in FIG. 15 can adjust the vehicle level of the vehicle 100, by supplying the gaseous matter from air supply sources 60A and 60B to the first and the second vehicle-body supporting apparatus 1c₁ and 1c₂. A changeover valve 61₁, is, arranged between the air supply source 60A and the first fluid path 7₁, whereas a changeover valve 61₂ is arranged between the air supply source 60B and the second fluid path 7₂. The changeover valves 61₁, 61₂ respectively include shutoff units 62₁, 62₂, check valves 63₁, 63₂, and exhaust units 64₁, 64₂.

Through independent supply of the gaseous matter to each of the first fluid path 7₁ and the second fluid path 7₂, the vehicle level can be made different at the right portion and the left portion, or at the front portion and the rear portion. The vehicle level can be adjusted based on each of the vehicle-body supporting apparatuses through feeding and exhaustion of the gaseous matter to/from the first fluid path 7₁ or the second fluid path 7₂. Therefore, it is possible to provide automatic leveling control, for example, according to which the vehicle-body supporting apparatuses control the vehicle to maintain previously set vehicle level using stroke sensors 32₁, 32₂ when the load acts on the vehicle-body supporting apparatus.

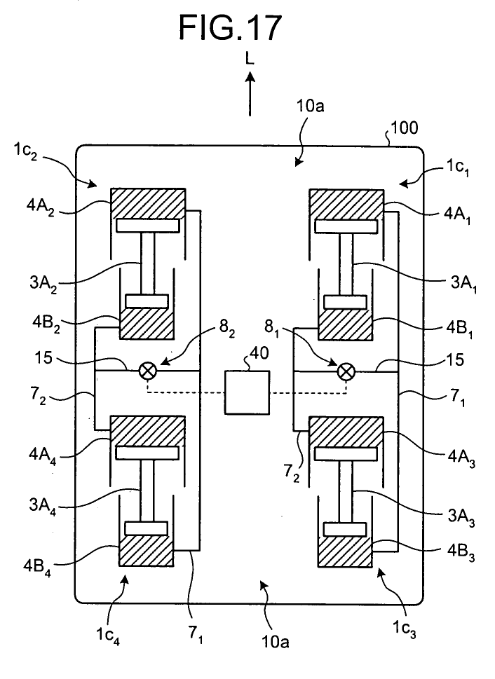

FIG. 17 is a schematic diagram of an example of the vehicle-body supporting system according to the second embodiment, where the air chambers of vehicle-body supporting apparatuses attached in the front portion and the rear portion of the vehicle, respectively, are connected with each other. In FIG. 17, a direction indicated by an arrow L represents the advancing direction of the vehicle 100. In a vehicle-body supporting system 10a, air chambers of the vehicle-body supporting apparatuses arranged front and rear of the vehicle at the same side are made to communicate with each other. Specifically, as shown in FIG. 17, air chambers of the front and rear vehicle-body supporting apparatuses forming a pair, i.e., the first and the third vehicle-body supporting apparatus 1c₁ and 1c₃, and the second and the fourth vehicle-body supporting apparatus 1c₂ and 1c₄, are made to communicate with each other.

In the example shown in FIG. 17, the first air chamber 4A₁ of the first vehicle-body supporting apparatus 1c₁ and the second air chamber 4B₃ of the third vehicle-body supporting apparatus 1c₃ are connected with each other via the first fluid path 7₁, whereas the second air chamber 4B₁ of the first vehicle-body supporting apparatus 1c₁ and the first air chamber 4A₃ of the third vehicle-body supporting apparatus 1c₃ are connected with each other via the second fluid path 7₂. Further, the first air chamber 4A₂ of the second vehicle-body supporting apparatus 1c₂ and the second air chamber 4B₄ of the fourth vehicle-body supporting apparatus 1c₄ are connected with each other via the first fluid path 7₁, whereas the second air chamber 4B₂ of the second vehicle-body supporting apparatus 1c₂ and the first air chamber 4A₄ of the fourth vehicle-body supporting apparatus 1c₄ are connected with each other via the second fluid path 7₂.

In the vehicle-body supporting system 10a, the first vehicle-body supporting apparatus 1c₁ and the third vehicle-body supporting apparatus 1c₃ are connected with each other via the first fluid path 7₁ and the second fluid path 7₂. The first fluid path 7₁ and the second fluid path 7₂ are connected with each other via the third fluid path 15 in which the first fluid-path opening/closing unit 8₁ is arranged. Further, the second vehicle-body supporting apparatus 1c₂ and the fourth vehicle-body supporting apparatus 1c₄ are connected with each other via the first fluid path 7₁ and the second fluid path 7₂. The first fluid path 7₁ and the second fluid path 7₂ are connected with each other via the third fluid path 15 in which the second fluid-path opening/closing unit 8₂ is arranged. The vibration damping control apparatus 40 can open/close the first fluid-path opening/closing unit 8₁ and the second fluid-path opening/closing unit 8₂ at the predetermined frequency (e.g., frequency of the vibrations that give uncomfortable feeling to the passenger) so as to damp the transmission of the vibrations of the predetermined frequency to the vehicle 100.

The first fluid-path opening/closing unit 8₁ and the second fluid-path opening/closing unit 8₂ are controlled based on signals sent from the first and the second vehicle-body acceleration sensors 30₁, 30₂, and the first and the second suspension-system acceleration sensors 31₁, 31₂. Thus, even when the natural frequency of the vibrating system including the vehicle-body supporting apparatus 1c and the mass of the vehicle body 100B supported thereby changes, data corresponding to the changes is acquired from the first and the second vehicle-body acceleration sensors 30₁ and 30₂ and the like for the control of the first fluid-path opening/closing unit 8₁ and the like, whereby the vibration damping effect can be exerted on the vehicle body 100B.

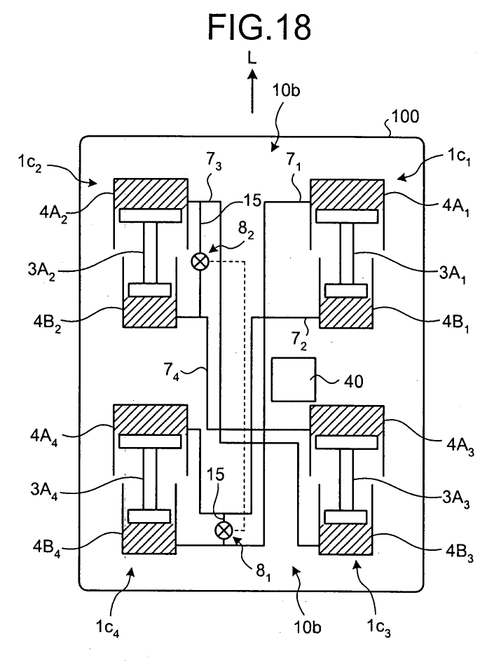

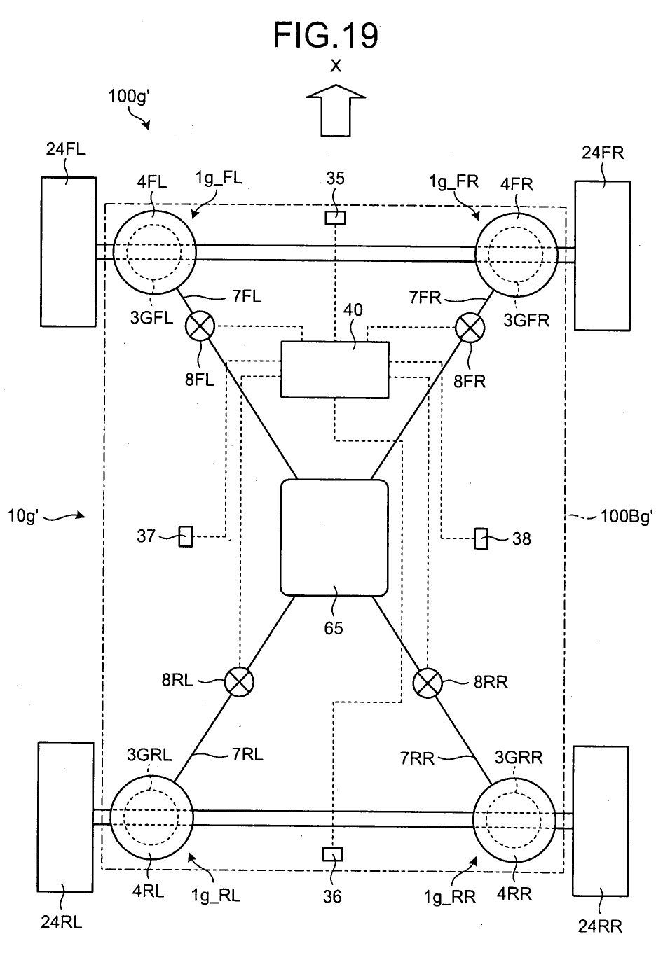

FIG. 18 is a schematic diagram of an example of the vehicle-body supporting system according to the second embodiment where the air chambers of the vehicle-body supporting apparatuses diagonally arranged as a pair are connected among the vehicle-body supporting apparatuses attached at four positions, i.e., at the front right, front left, rear right, and rear left positions of the vehicle. In FIG. 18, the direction shown by an arrow L represents the advancing direction of the vehicle 100. Specifically, as shown in FIG. 18, in the vehicle-body supporting system 10b, the air chambers are communicated between the first vehicle-body supporting apparatus 1c₁ and the fourth vehicle-body supporting apparatus 1c₄ arranged diagonally, and between the second vehicle-body supporting apparatus 1c₂ and the third vehicle-body supporting apparatus 1c₃, among the vehicle-body supporting apparatuses 1c attached at four positions in the vehicle 100.

In the example shown in FIG. 18, the first air chamber 4A₁ of the first vehicle-body supporting apparatus 1c₁ and the second air chamber 4B₄ of the fourth vehicle-body supporting apparatus 1c₄ are connected with each other via the first fluid path 7₁, whereas the second air chamber 4B₁ of the first vehicle-body supporting apparatus 1c₁ and the first air chamber 4A₄ of the fourth vehicle-body supporting apparatus 1c4 are connected with each other via the second fluid path 7₂. Further, the first air chamber 4A₂ of the second vehicle-body supporting apparatus 1c₂ and the second air chamber 4B₃ of the third vehicle-body supporting apparatus 1c₃ are connected with each other via the third fluid path 7₃, whereas the second air chamber 4B₂ of the second vehicle-body supporting apparatus 1c₂ and the first air chamber 4A₃ of the third vehicle-body supporting apparatus 1c₃ are connected with each other via the fourth fluid path 7₄.

In the vehicle-body supporting system 10b, the first fluid path 7₁ and the second fluid path 7₂ are connected with each other via the third fluid path 15 in which the first fluid-path opening/closing unit 8₁ is arranged. Further, the third fluid path 7₃ and the fourth fluid path 7₄ are connected with each other via the third fluid path 15 in which the second fluid-path opening/closing unit 8₂ is arranged. The vibration damping control apparatus 40 can open/close the first fluid-path opening/closing unit 8₁ and the second fluid-path opening/closing unit 8₂ at the predetermined frequency (e.g., frequency of the vibrations that give uncomfortable feeling to the passenger) so as to damp the transmission of the vibrations of the predetermined frequency to the vehicle 100.

The first fluid-path opening/closing unit 8₁ and the second fluid-path opening/closing unit 8₂ are controlled based on signals sent from the first and the second vehicle-body acceleration sensors 30₁, 30₂, and the first and the second suspension-system acceleration sensors 31₁, 31₂. Thus, even when the natural frequency of the vibrating system including the vehicle-body supporting apparatus 1c and the mass of the vehicle body 100B supported thereby changes, data corresponding to the changes is acquired from the first and the second vehicle-body acceleration sensors 30₁ and 30₂ and the like for the control of the first fluid-path opening/closing unit 8₁ and the like, whereby the vibration damping effect can be exerted on the vehicle body 100B.

As can be seen from the foregoing, the frequency to open/close the fluid-path opening/closing unit is controlled based on the actual vibrations of the vehicle. Therefore, even when the natural frequency of the vibrating system including the vehicle-body supporting apparatus and the mass of the vehicle supported thereby changes, the frequency to open/close the fluid-path opening/closing unit can be controlled so as to reflect the change, whereby the vibration damping effect can be exerted on the vehicle.

Further, the vehicle-body supporting system of the second embodiment supports the load in a stable manner with the first and the second air chambers, and the first and the second fluid paths are provided to make the first and the second air chambers communicate with each other in buffer apparatuses forming a pair. Thus, in the buffer apparatuses forming a pair, the spring constant becomes higher when operating in the opposite phases than when operating in the same phase. With the arrangement of such pair of buffer apparatuses at the right and the left or at the front and the rear of the vehicle, the spring constant of the buffer apparatus can be easily changed according to the driving condition of the vehicle.

### Third Embodiment

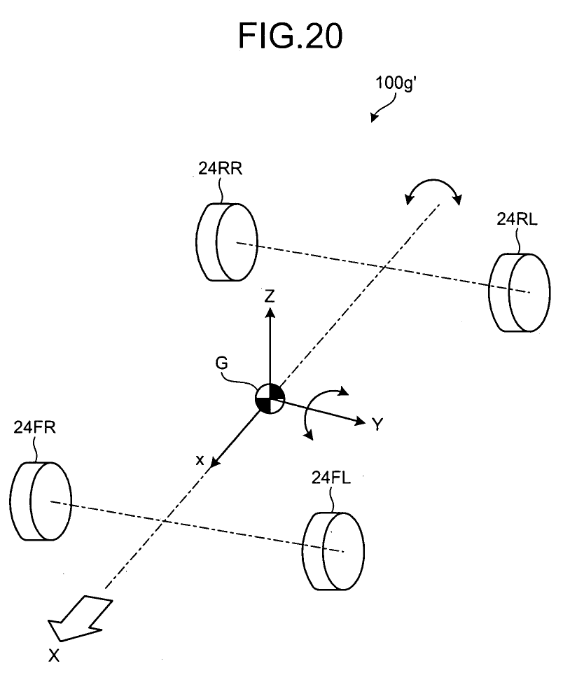

FIG. 19 is a diagram of a configuration of a vehicle-body supporting system for explaining a control example of a vehicle-body supporting system according to a third embodiment. FIG. 20 is a diagram for explaining a behavior of the vehicle. The control example is described based on an example which employs the vehicle-body supporting apparatus and the vehicle-body supporting system 10g′ according to the first embodiment to suppress the rotational vibrations such as pitching or rolling of the vehicle. The control of the vehicle-body supporting system described below can be realized by the vibration damping control apparatus 40 (see FIG. 4A).

The vehicle 100g′ shown in FIG. 19 advances in a direction indicated by an arrow X of FIG. 19. Therefore, the forward direction the vehicle 100g′ advances is the direction indicated by the arrow X in FIG. 19. The vehicle 100g′ has a left-side front wheel 24FL and a right-side front wheel 24FR in the forward direction, and a left-side rear wheel 24RL and a right-side rear wheel 24RR in the backward direction. Here, the left-side front wheel 24FL, the right-side rear wheel 24RR, and the like are collectively referred to merely as wheels, when appropriate. The right and the left are determined based on the forward advancing direction of the vehicle 100g′. With respect to the front and the rear, the front is the forward advancing direction of the vehicle 100g′, whereas the rear is the opposite direction of the advancing direction of the vehicle 100g′.

In the vehicle 100g′ shown in FIG. 19, the vehicle-body supporting system 10g′ supports a vehicle body 100Bg′. In the vehicle-body supporting system 10g′, all the air chambers provided in each of the vehicle-body supporting apparatuses are connected to a common air storage chamber. The air storage chamber may be arranged corresponding to each of the vehicle-body supporting apparatuses provided in the vehicle-body supporting system 10g′.

The vehicle-body supporting system 10g′ includes a front left-side vehicle-body supporting apparatus 1g_FL, a front right-side vehicle-body supporting apparatus 1g_FR, a rear left-side vehicle-body supporting apparatus 1g_RL, and a rear right-side vehicle-body supporting apparatus 1g_RR. The front left-side vehicle-body supporting apparatus 1g_FL, the front right-side vehicle-body supporting apparatus 1g_FR, the rear left-side vehicle-body supporting apparatus 1g_RL, and the rear right-side vehicle-body supporting apparatus 1g_RR have a front left-side air chamber 4FL, a front right-side air chamber 4FR, a rear left-side air chamber 4RL, and a rear right-side air chamber 4RR, respectively. The front left-side air chamber 4FL, the front right-side air chamber 4FR, the rear left-side air chamber 4RL, and the rear right-side air chamber 4RR receive inputs of vibrations from the wheels via a front left-side load-transfer member 3GFL, a front right-side load-transfer member 3GFR, a rear left-side load-transfer member 3GRL, and a rear right-side load-transfer member 3GRR, respectively.

In the vehicle-body supporting system 10g′, all of the front left-side air chamber 4FL, the front right-side air chamber 4FR, the rear left-side air chamber 4RL, and the rear right-side air chamber 4RR are connected to an air storage chamber 65. Specifically, the front left-side air chamber 4FL and the air storage chamber 65 are connected via a front left-side fluid path 7FL, the front right-side air chamber 4FR and the air storage chamber 65 are connected via a rear left-side fluid path 7FR, the rear left-side air chamber 4RL and the air storage chamber 65 are connected via a rear left-side fluid path 7RL, and the rear right-side air chamber 4RR and the air storage chamber 65 are connected via a rear right-side fluid path 7RR. Further, the front left-side fluid path 7FL, the front right-side fluid path 7FR, the rear left-side fluid path 7RL, and the rear right-side fluid path 7RR are provided with a front left-side fluid-path opening/closing unit 8FL, a front right-side fluid-path opening/closing unit 8FR, a rear left-side fluid-path opening/closing unit 8RL, and a rear right-side fluid-path opening/closing unit 8RR, respectively.

A front acceleration sensor 35 is arranged at the front side of the vehicle body 100Bg′, whereas a rear acceleration sensor 36 is arranged at the rear side of the vehicle body 100Bg′. Further, a left-side acceleration sensor 37 is arranged at the left side of the vehicle body 100Bg′, whereas a right-side acceleration sensor 38 is arranged at the right side of the vehicle body 100Bg′. The front acceleration sensor 35 and the rear acceleration sensor 36 detect the pitching of the vehicle 100g′ whereas the left-side acceleration sensor 37 and the right-side acceleration sensor 38 detect the roll of the vehicle 100g′. In other words, the front acceleration sensor 35 and the rear acceleration sensor 36 work as a pitching detector of the vehicle 100g′, whereas the left-side acceleration sensor 37 and the right-side acceleration sensor 38 work as a roll detector of the vehicle 100g′.

The front acceleration sensor 35, the rear acceleration sensor 36, the left-side acceleration sensor 37, and the right-side acceleration sensor 38 are connected to the vibration damping control apparatus 40 and configured so that the vibration damping control apparatus 40 can acquire and utilize signals detected by these acceleration sensors for the control. The pitching and the rolling of the vehicle 100g′ may be detected by an angular accelerometer or an angular velocimeter (which is realized, for example by microelectronics or gyros) instead of the plural sensors described above. When the angular accelerometer or the like is arranged at one position of the vehicle body 100Bg′, the pitching vibration or the rolling vibration can be detected. When a three-dimensional angular accelerometer or a three-dimensional angular velocimeter is employed, both the pitching and the rolling can be detected by a single device.

As shown in FIG. 20, an axis passing through a gravity center G of the vehicle 100g′ and parallel to the advancing direction of the vehicle 100g′ is set as x-axis, an axis passing through the gravity center G of the vehicle 100g′ and parallel to a direction orthogonal to a ground surface in contact with the vehicle 100g′ is set as z-axis, and an axis passing through the gravity center G of the vehicle 100g′ and orthogonal to both the x-axis and the z-axis is set as y-axis. In this case, rotation of the vehicle 100g′ around the y-axis is called pitching, whereas rotation of the vehicle 100g′ around the x-axis is called rolling.

In the vehicle-body supporting system 10g′, when the pitching of the vehicle 100g′ is to be suppressed, the frequency setting unit 41 of the vibration damping control apparatus 40 acquires acceleration information from the front acceleration sensor 35 and the rear acceleration sensor 36. The information may be acquired by a single angular accelerometer or an angular velocimeter. The frequency setting unit 41 calculates the frequency of the pitching (i.e., pitching frequency) of the vehicle 100g′ based on the acquired acceleration, and sets the calculated frequency to the notch frequency. The frequency setting unit 41 determines the timing of opening/closing (hereinafter referred to as opening/closing timing) of at least one of the front left-side fluid-path opening/closing unit 8FL and the rear left-side fluid-path opening/closing unit 8RL, or at least one of the front right-side fluid-path opening/closing unit 8FR and the rear right-side fluid-path opening/closing unit 8RR so as to realize the set notch frequency. As mentioned above, the notch frequency may be extracted as a frequency exceeding predetermined vibration energy. Alternatively, when there are plural notch frequencies, the plural notch frequencies may be superimposed with each other for the determination of the opening/closing timing (the same applies hereinafter).

The communicating-time setting unit 42 of the vibration damping control apparatus 40 sets the valve-opening time tb of at least one of the front left-side fluid-path opening/closing unit 8FL and the rear left-side fluid-path opening/closing unit 8RL, or at least one of the front right-side fluid-path opening/closing unit 8FR and the rear right-side fluid-path opening/closing unit 8RR based on the magnitude of vibrational power of prominent frequency in the rolling vibration or the pitching vibration (see FIG. 9). Alternatively, the communicating-time setting unit 42 may set the valve-opening time tb based on the supported load of the apparatus such as the front left-side vehicle-body supporting apparatus 1g_FL or the rear right-side vehicle-body supporting apparatus 1g_RR, or the like.

The valve controller 43 of the vibration damping control apparatus 40 opens/closes at least one of the front left-side fluid-path opening/closing unit 8FL and the rear left-side fluid-path opening/closing unit 8RL, or at least one of the front right-side fluid-path opening/closing unit 8FR and the rear right-side fluid-path opening/closing unit 8RR at the opening/closing timing set by the frequency setting unit 41 and with the width of the valve-opening command pulse set by the communicating-time setting unit 42. Thus, the spring stiffness of the front left-side vehicle-body supporting apparatus 1g_FL, the rear right-side vehicle-body supporting apparatus 1g_RR, and the like decreases with respect to the pitching frequency mentioned above. As a result, the gain of the vehicle-body supporting apparatus with respect to the pitching frequency approaches zero. As a result, the transmission of the vibrations of the pitching frequency to the vehicle body 100Bg′ of the vehicle 100g′ can be damped, and the pitching of the vehicle 100g′ is suppressed. A control performed to suppress the roll of the vehicle 100g′ will be described.

In the vehicle-body supporting system 10g′, when the roll of the vehicle 100g′ is to be suppressed, the frequency setting unit 41 of the vibration damping control apparatus 40 acquires vibration information from the left-side acceleration sensor 37 and the right-side acceleration sensor 38, or from the angular accelerometer or an angular velocimeter. The frequency setting unit 41 calculates the frequency of the roll (i.e., roll frequency) of the vehicle 100g′ based on the acquired vibration information, and sets the calculated frequency as the notch frequency. The frequency setting unit 41 determines the timing of opening/closing (hereinafter referred to as opening/closing timing) of at least one of the front left-side fluid-path opening/closing unit 8FL and the front right-side fluid-path opening/closing unit 8FR, or at least one of the rear left-side fluid-path opening/closing unit 8RL and the rear right-side fluid-path opening/closing unit 8RR based on the set notch frequency.

The communicating-time setting unit 42 of the vibration damping control apparatus 40 sets the valve-opening time tb (see FIG. 9) for each vehicle-body supporting apparatus based on the supported load of the front left-side vehicle-body supporting apparatus 1g_FL or the rear right-side vehicle-body supporting apparatus 1g_RR, or the like or the power of prominent frequency of the rotational vibrations such as the pitching and the rolling. Then, the valve controller 43 of the vibration damping control apparatus 40 opens/closes at least one of the front left-side fluid-path opening/closing unit 8FL and the front right-side opening/closing unit 8FR, or at least one of the rear left-side fluid-path opening/closing unit 8RL and the rear right-side fluid-path opening/closing unit 8RR at the opening/closing timing set by the frequency setting unit 41 and with the width of the valve-opening command pulse set by the communicating-time setting unit 42. Thus, the spring stiffness of the front left-side vehicle-body supporting apparatus 1g_FL and the rear right-side vehicle-body supporting apparatus 1g_RR and the like decreases with respect to the roll frequency. As a result, the gain of the vehicle-body supporting apparatus approaches zero with respect to the roll frequency. As a result, the vehicle-body supporting system 10g′ of the third embodiment can damp the transmission of vibrations of the roll frequency to the vehicle body 100Bg′, and the roll of the vehicle 100g′ is suppressed.

Further, to damp the vibration in the diagonal direction of the vehicle 100g′, the frequency of the vibration is set as the notch frequency. Then, the front left-side fluid-path opening/closing unit 8FL and the rear right-side fluid-path opening/closing unit 8RR (or the rear left-side fluid-path opening/closing unit 8RL and the front right-side fluid-path opening/closing unit 8FR) are opened/closed at the notch frequency. Thus, in the vehicle-body supporting system 10g′ of the third embodiment, the pitching and the rolling of the vehicle 100g′ are suppressed, so that the stability of the vehicle 100g′ and the driving comfort of the passenger can be enhanced.

As has been described above, the vehicle-body supporting apparatus according to one aspect of the present invention includes the air chamber that is filled with a gaseous matter, and the vibration input unit that inputs the vibration to the air chamber by reciprocating relative to the air chamber. The vehicle-body supporting apparatus opens/closes the fluid path connected to the air chamber at a predetermined frequency corresponding to a frequency of reciprocation of the vibration input unit relative to the air chamber. With the above configuration, the vehicle-body supporting apparatus works as a frequency filter which has a gain of zero for the predetermined frequency and a gain of approximately 1.0 for other frequencies. Thus, the vibration of the predetermined frequency is blocked by the vehicle-body supporting apparatus and is not transmitted to the vehicle body supported by the vehicle-body supporting apparatus substantially. Therefore, even when the natural frequency of the vibrating system including the vehicle-body supporting apparatus and the vehicle body supported thereby changes, the vehicle-body supporting apparatus can exert a vibration damping effect on the vehicle body which is a supported object by changing the frequency of opening/closing of the fluid path connected to the air chamber according to the change in the natural frequency while supporting the static load.

It is preferable that the spring constant of the vehicle-body supporting apparatus can be changed according to the driving condition of the vehicle in order to realize driving stability suitable for the driving condition of the vehicle such as straight running and turning. In the vehicle-body supporting system of one aspect of the present invention, the load is stably supported by the first air chamber and the second air chamber, and further, the first fluid path and the second fluid path are provided to connect the first air chamber and the second air chamber with each other in the pair of buffer apparatuses. Thus, the spring constant is higher when the pair of buffer apparatuses operate in opposite phases, than when the pair of buffer apparatuses operate in the same phase. By arranging such a pair of buffer apparatuses at the right, left, front, and rear of the vehicle, the spring constant of the buffer apparatuses can be easily changed according to the driving condition of the vehicle.

According to one aspect of the present invention, the vehicle-body supporting apparatus and the vehicle-body supporting system can exert the vibration suppressing effect on the vehicle while supporting the load of the vehicle even when the natural frequency of the vibrating system composed of the vehicle-body supporting apparatus and the mass of the vehicle supported thereby changes.

As can be seen from the foregoing, the vehicle-body supporting apparatus and the vehicle-body supporting system according to the present invention are useful for supporting a vehicle body, and more particularly, suitable for suppressing the vibration transmission of the frequency whose transmission to the supported vehicle body is not desirable.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle-body supporting apparatus provided between a vehicle body of a vehicle and a wheel to support the vehicle body, comprising:
an air chamber that is filled with a gaseous matter;
a vibration input unit that inputs at least one of vibration from the vehicle body, and vibration from the wheel to the air chamber by reciprocating relative to the air chamber;
a fluid path that the gaseous matter in the air chamber passes through; and
a fluid-path opening/closing unit that is attached to the fluid path to open/close the fluid path at predetermined frequency corresponding to a frequency of reciprocation of the vibration input unit relative to the air chamber.

2. The vehicle-body supporting apparatus according to claim 1, further comprising
an air amount detector that detects an amount of the gaseous matter filling the air chamber; and
an air supply unit that replenishes the gaseous matter into the air chamber when the amount of the gaseous matter filling in the air chamber as detected by the air amount detector is equal to or smaller than a predetermined threshold.

3. The vehicle-body supporting apparatus according to claim 1, wherein
the air chamber includes a first air chamber and a second air chamber, the vibration input unit is arranged between the first air chamber and the second air chamber, and the fluid path connects the first air chamber and the second air chamber.

4. The vehicle-body supporting apparatus according to claim 3, wherein
the second air chamber is arranged opposite to the first air chamber, and
the vibration input unit is supported by the first air chamber and the second air chamber, and a load-supporting area of the vibration input unit in contact with the first air chamber is larger than a load-supporting area of the vibration input unit in contact with the second air chamber.

5. The vehicle-body supporting apparatus according to claim 1, further comprising
a vibration detector that is attached to the vehicle to detect at least one of sprung vibration and unsprung vibration of the vehicle, wherein
the vibration detector finds a frequency with a maximum vibrational power, and the fluid-path opening/closing unit is opened/closed at the frequency found, an integral multiple of the frequency found, or a frequency obtained by dividing the frequency found by an integer.

6. The vehicle-body supporting apparatus according to claim 5, wherein
power of the frequency with the maximum vibrational power is identified, and a ratio of an opening time to a closing time of the opening/closing of the fluid-path opening/closing unit is changed according to a magnitude of the vibrational power.

7. The vehicle-body supporting apparatus according to claim 5, wherein
the vibration detector finds plural frequencies in a descending order of a magnitude of the vibrational power, and
the fluid-path opening/closing unit is opened/closed at the plural frequencies found, integral multiples of the frequencies found, or frequencies obtained by dividing the plural frequencies by an integer.

8. The vehicle-body supporting apparatus according to claim 7, wherein
a ratio of an opening time to a closing time of the opening/closing of the fluid-path opening/closing unit is changed for each of the plural frequencies found according to a magnitude of the vibrational power of each of the plural frequencies found.

9. The vehicle-body supporting apparatus according to claim 1, further comprising
an elastic body that supports the vibration input unit.

10. A vehicle-body supporting system comprising:
vehicle-body supporting apparatuses each arranged between a vehicle body of a vehicle and a wheel to support the vehicle body, each of the vehicle-body supporting apparatuses including
a first air chamber and a second air chamber filled with a gaseous matter, and
a vibration input unit that is arranged between the first air chamber and the second air chamber to input at least one of vibration from the vehicle body and vibration from the wheel to the first air chamber and the second air chamber by reciprocating relative to the first air chamber and the second air chamber;
a first fluid path that connects the first air chamber of one vehicle-body supporting apparatus of a pair of the vehicle-body supporting apparatuses and the second air chamber of another vehicle-body supporting apparatus of the pair of the vehicle-body supporting apparatuses;
a second fluid path that connects the second air chamber of the one vehicle-body supporting apparatus and the first air chamber of the another vehicle-body supporting apparatus; and
a fluid-path opening/closing unit that is attached to a third fluid path connecting the first fluid path and the second fluid path with each other to open/close the third fluid path at a predetermined frequency corresponding to a frequency of reciprocation of the vibration input unit relative to the first air chamber and the second air chamber.

11. The vehicle-body supporting system according to claim 10, wherein
the pair of the vehicle-body supporting apparatuses is attached to the vehicle one at a right and another at a left.

12. The vehicle-body supporting system according to claim 10, wherein
the pair of the vehicle-body supporting apparatuses is attached to the vehicle both at a same side of the vehicle, and one at a front and another at a rear.

13. The vehicle-body supporting system according to claim 10, wherein
the pair of the vehicle-body supporting apparatuses is attached to the vehicle at diagonal positions.

14. The vehicle-body supporting system according to claim 10, further comprising
a vibration detector that is attached to the vehicle to detect at least one of sprung vibration and unsprung vibration of the vehicle, wherein
a vibrational component detected by the vibration detector and having a vibrational power equal to or higher than a predetermined vibrational power is selected as a frequency of vibration whose transmission is to be damped, and
the fluid-path opening/closing unit is opened/closed at the selected frequency of the vibration whose transmission is to be damped, an integer multiple of the selected frequency, or a frequency obtained by dividing the selected frequency by an integer.

15. The vehicle-body supporting system according to claim 14, wherein
the vibrational component detected by the vibration detector and having a vibrational power equal to or higher than the predetermined vibrational power is selected as a frequency of vibration whose transmission is to be damped, and a ratio of an opening time to a closing time of opening/closing of the fluid-path-opening/closing unit is changed according to a magnitude of each of the vibrational power.

16. The vehicle-body supporting system according to claim 14, wherein
the vibrational component having a vibrational power equal to or higher than the predetermined vibrational power is selected as a frequency of vibration whose transmission is to be damped, plural frequencies are selected in a descending order of magnitude of the vibrational power, and the fluid-path opening/closing unit is opened/closed at integral multiples of the selected plural frequencies or at frequencies obtained by dividing the selected plural frequencies by an integer.

17. The vehicle-body supporting system according to claim 16, wherein
plural frequencies are selected in a descending order of magnitude of the vibrational power from the plural frequencies set, and a ratio of an opening time to a closing time of the opening/closing of the fluid-path opening/closing unit is changed for each of the frequencies selected according to the magnitude of the vibrational power of the frequencies selected.

18. A vehicle-body supporting system comprising:
a vehicle-body supporting apparatus that is arranged between a vehicle body of a vehicle and a wheel to support the vehicle body, the vehicle-body supporting apparatus including
an air chamber that is filled with a gaseous matter, and
a vibration input unit that inputs at least one of vibration from the vehicle and vibration from the wheel to the air chamber by reciprocating relative to the air chamber;
an air storage chamber that stores the gaseous matter filling the air chamber inside;
a fluid path that connects the air chamber of the vehicle-body supporting apparatus and the air storage chamber; and
a fluid-path opening/closing unit that is attached to the fluid path to open/close the fluid path at a predetermined frequency corresponding to a frequency of reciprocation of the vibration input unit relative to the air chamber.

19. The vehicle-body supporting system according to claim 18, wherein
the air chambers of plural vehicle-body supporting apparatuses are connected to the corresponding air storage chambers, respectively.

20. The vehicle-body supporting system according to claim 18, wherein
the air chambers of at least one set of the vehicle-body supporting apparatuses are connected to the common air storage chamber.

21. The vehicle-body supporting system according to claim 18, wherein
the air chambers of all the vehicle-body supporting apparatuses are connected to the common air storage chamber.

22. The vehicle-body supporting system according to claim 18, further comprising
a vibration detector that is attached to the vehicle to detect at least one of sprung vibration and unsprung vibration of the vehicle, wherein
vibration detected by the vibration detector and having a vibrational power equal to or higher than a predetermined vibrational, power is selected as vibration whose transmission is to be damped, and the fluid-path opening/closing unit opens/closes the fluid path at a selected frequency of the vibration whose transmission is to be damped, an integral multiple of the frequency of the selected vibration, or a frequency obtained by dividing the selected vibration by an integer.

23. The vehicle-body supporting system according to claim 22, wherein
power of the predetermined frequency set is identified, and a ratio of an opening time to a closing time of the opening/closing of the fluid-path opening/closing unit is changed according to a magnitude of vibrational power of the predetermined frequency set.

24. The vehicle-body supporting system according to claim 22, wherein
plural frequencies are selected in a descending order of magnitude of the vibrational power from frequencies of plural input vibrations detected, and the fluid-path opening/closing unit is opened/closed at plural frequencies selected, integer multiples of the frequencies selected, or frequencies obtained by dividing the frequencies selected by an integer.

25. The vehicle-body supporting system according to claim 24, wherein
plural frequencies are selected in a descending order of magnitude of vibrational power from frequencies of plural input vibrations detected, and a ratio of an opening time to a closing time of the opening/closing of the fluid-path opening/closing unit is changed for each of the frequencies selected according to magnitude of power of the frequencies selected.

26. The vehicle-body supporting system according to claim 18, wherein
the vehicle-body supporting apparatuses support front wheels and rear wheels of the vehicle, respectively, and a frequency of pitching of the vehicle is set as the predetermined frequency, and the fluid-path opening/closing units open/close the fluid paths.

27. The vehicle-body supporting system according to claim 18, wherein
the vehicle-body supporting apparatuses support left wheels and right wheels of the vehicle, respectively, and a frequency of roll of the vehicle is set as the predetermined frequency, and the fluid-path opening/closing units open/close the fluid paths.
